(19) United States
(12) Patent Application Publication
(10) Pub. No.: US 2025/0071029 A1
(43) Pub. Date: Feb. 27, 2025

(54) SYSTEMS AND METHODS FOR INTER-NODE VERIFICATION OF AIML MODELS

(71) Applicant: Telefonaktiebolaget LM Ericsson (publ), Stockholm (SE)

(72) Inventors: Pablo Soldati, Solna (SE); Philipp Bruhn, Aachen (DE); Luca Lunardi, Genova (IT); Angelo Centonza, Granada (ES); Henrik Rydén, Stockholm (SE); German Bassi, Årsta (SE)

(21) Appl. No.: 18/724,325

(22) PCT Filed: Dec. 29, 2022
(86) PCT No.: PCT/EP2022/087996

§ 371 Date: Jun. 26, 2024

Related U.S. Application Data
(60) Provisional application No. 63/294,921, filed on Dec. 30, 2021.

(51) Int. Cl. H04L 41/16; H04W 24/02

(52) U.S. Cl. CPC H04L 41/16; H04W 24/02

(57) ABSTRACT

Systems and methods for inter-node verification of models are disclosed. Some embodiments of the present disclosure propose a method for a first network node to provide a model to a second network node together with configurations/instructions/semantics information for verifying (e.g., testing and/or validating) the model. In some embodiments, the model is an Artificial Intelligence (AI) and/or Machine Learning (ML) model. This may enable a first network node, responsible for training an AIML model and providing it to a second network node, to specify whether, when, and how the model can, should, or must be verified by the second network node prior to using the model. This allows the first network node to ensure that the model, for which it is responsible, is correctly set up, applied, or installed by the second network node and works as expected before the second network uses the model, for instance, for inference.

### RELATED APPLICATIONS

This application claims the benefit of provisional patent application Ser. No. 63/294,921, filed Dec. 30, 2021, the disclosure of which is hereby incorporated herein by reference in its entirety.

### TECHNICAL FIELD The current disclosure relates generally to verifying a model.

### BACKGROUND

A Study Item (SI) “Enhancement for Data Collection for NR and EN-DC” is defined in 3GPP RP-201620.

The study item aims to study the functional framework for RAN intelligence enabled by further enhancement of data collection through use cases, examples etc. and identify the potential standardization impacts on current NG-RAN nodes and interfaces.

The detailed objectives of the SI are listed as follows:
Study high level principles for RAN intelligence enabled by AI, the functional framework (e.g., the AI functionality and the input/output of the component for AI enabled optimization) and identify the benefits of AI enabled NG-RAN through possible use cases e.g., energy saving, load balancing, mobility management, coverage optimization, etc.:
a) Study standardization impacts for the identified use cases including: the data that may be needed by an AI function as input and data that may be produced by an AI function as output, which is interpretable for multi-vendor support.
b) Study standardization impacts on the node or function in current NG-RAN architecture to receive/provide the input/output data.
c) Study standardization impacts on the network interface(s) to convey the input/output data among network nodes or AI functions.

As part of the SI work, a Text Proposal (TP) has been agreed for 3GPP Technical Report (TR) 37.817 in R3-216278, as reported below.

The following high-level principles should be applied for AI-enabled RAN intelligence:
The detailed AI/ML algorithms and models for use cases are implementation specific and out of RAN3 scope.
The study focuses on AI/ML functionality and corresponding types of inputs/outputs.
The input/output and the location of the Model Training and Model Inference function should be studied case by case.
The study focuses on the analysis of data needed at the Model Training function from Data Collection, while the aspects of how the Model Training function uses inputs to train a model are out of RAN3 scope.
The study focuses on the analysis of data needed at the Model Inference function from Data Collection, while the aspects of how the Model Inference function uses inputs to derive outputs are out of RAN3 scope.
Where AI/ML functionality resides within the current RAN architecture, depends on deployment and on the specific use cases.
The Model Training and Model Inference functions should be able to request, if needed, specific information to be used to train or execute the AI/ML algorithm and to avoid reception of unnecessary information. The nature of such information depends on the use case and on the AI/ML algorithm.
The Model Inference function should signal the outputs of the model only to nodes that have explicitly requested them (e.g., via subscription), or nodes that are subject to actions based on the output from Model Inference.
An AI/ML model used in a Model Inference function has to be initially trained, validated and tested before deployment.
NG-RAN is prioritized; EN-DC is included in the scope. FFS on whether MR-DC should be down-prioritized.
A general framework and workflow for AI/ML optimization should be defined and captured in the TR. The generalized workflow should not prevent to “think beyond” the workflow if the use case requires so.
User data privacy and anonymization should be respected during AI/ML operation.

The Functional Framework for RAN Intelligence comprised in R3-216278 is shown in FIG. 4.2-1 of the same TP and as FIG. 1 in the current disclosure.

The current definitions of the individual blocks and signals represented in the Function Framework are detailed below.
Data Collection is a function that provides input data to Model training and Model inference functions. AI/ML algorithm specific data preparation (e.g., data pre-processing and cleaning, formatting, and transformation) is not carried out in the Data Collection function.
Examples of input data may include measurements from UEs or different network entities, feedback from Actor, output from an AI/ML model.
   Training Data: Data needed as input for the AI/ML Model Training function.
   Inference Data: Data needed as input for the AI/ML Model Inference function.
Model Training is a function that performs the ML model training, validation, and testing which may generate model performance metrics as part of the model testing procedure. The Model Training function is also responsible for data preparation (e.g., data pre-processing and cleaning, formatting, and transformation) based on Training Data delivered by a Data Collection function, if required.
   Model Deployment/Update: Used to initially deploy a trained, validated, and tested AI/ML model to the Model Inference function or to deliver an updated model to the Model Inference function.
      Note: Details of the Model Deployment/Update process as well as the use case specific AI/ML models transferred via this process are out of RAN3 Rel-17 study scope. The feasibility to single-vendor or multi-vendor environment has not been studied in RAN3 Rel-17 study.
Model Inference is a function that provides AI/ML model inference output (e.g., predictions or decisions). It is FFS whether it provides model performance feedback to Model Training function. The Model inference function is also responsible for data preparation (e.g., data pre-processing and cleaning, formatting, and transformation) based on Inference Data delivered by a Data Collection function, if required.
   Output: The inference output of the AI/ML model produced by a Model Inference function.
      Note: Details of inference output are use case specific.
   (FFS) Model Performance Feedback: Applied if certain information derived from Model Inference function is suitable for improvement of the AI/ML model trained in Model Training function. Feedback from Actor or other network entities (via Data Collection function) may be needed at Model Inference function to create Model Performance Feedback.
   Note: Details of the Model Performance Feedback process are out of RAN3 Rel-17 study scope.
Actor is a function that receives the output from the Model inference function and triggers or performs corresponding actions. The Actor may trigger actions directed to other entities or to itself.
Feedback: Information that may be needed to derive training or inference data or performance feedback.

The following text is presented at RAN3#113-e in R3-213468 in relation to an ML model validation:

Validating the ML model is important to ensure its accuracy. Basically, when the model is trained, validating the model with different set of data (e.g., different from training data) provides an opportunity to further improve the model quality, which further avoids making wrong decisions taken by the machine in the real-life prediction.

In this case, besides training data provided to “Model Training” function and inference data provided to “Model Inference” function, “Data Collection” should also provide validation data to “Model Training”, so that the accuracy of the trained model can be guaranteed.

Proposal 13: “Data Collection” function should also provide validation data to “Model Training” function for ML model validation.

Proposal 14: “Model Training” should also perform model validation based on the validation data set received from “Data Collection” to further improve model accuracy.

Improved systems and methods for verification of models are needed.

### SUMMARY

Systems and methods for inter-node verification of models are disclosed. Some embodiments of the present disclosure propose a method for a first network node to provide a model to a second network node together with configurations/instructions/semantics information for verifying (e.g., testing and/or validating) the model. In some embodiments, the model is an Artificial Intelligence (Al) and/or Machine Learning (ML) model. This may enable a first network node, responsible for training an AIML model and providing it to a second network node, to specify whether, when, and how the model can, should, or must be verified by the second network node prior to using the model. This allows the first network node to ensure that the model, for which it is responsible, is correctly set up, applied, or installed by the second network node and works as expected before the second network uses the model, for instance, for inference.

In one embodiment of the method, the first network node may provide a set of reference data samples to verify the AIML model. In one example the set of reference data samples can be provided as part of the configuration for verifying an AI/ML model. In another example, the provided reference data samples could be explicitly associated to one or more AIML models.

Embodiments of the current disclosure disclose that the second network node could be required/configured to verify (e.g., test and/or validate) an AIML model provided by the first network node according to the received instruction/configuration provided prior to using the AIML model, e.g., for inference.

Similarly, the second network node could be required to validate that the inputs required by the model can be received over the interfaces connecting the second network node to other parts of the system, according to the received instructions/configurations/semantics provided prior to using the AIML model, e.g., for inference.

In other examples, testing/verification/validation according to the instruction/configuration/semantics provided by the first network node may be required or needed if the second network node or a third network node re-trains or modifies the AIML model provided by the first network node.

Additional embodiments of the solution disclose that the first network node may require the second network node to provide information related to verifying (testing and/or validation) or any other kind of evaluation of an AIML model provided by the first network node (for instance, upon the second network node or a third network node having re-trained/modified AIML model to the first network node). In one example, the first network node can control whether, when, and how it must be notified by the second network node about the result of verification and/or validation.

Additional embodiments of the solution disclose that the second network node may, without previous configurations/instructions from the first network node, run the model verification process and notify the first network node of inconsistencies between the instructions/configurations/semantics relative to the inputs and/or outputs, provided prior to using the AIML model, and the actual availability of the inputs and/or outputs over the connected interfaces to the second network node.

The second network node may signal the result of the verification/testing/validation process to any other external node or system in the network (for example another network node), to enable system diagnostic and system optimization.

Some embodiments of the current disclosure include a method for a first network node to enable and/or control whether, when, and how an AIML model (possibly trained by the first network node) could, should, or must be verified (e.g., tested and/or validated) by a second network node or by a third network node, and whether, when, and how the first network node must be notified about the result of the said verification (e.g., testing and/or validation). In some cases, the AIML model could be provided by the first network node to the second network node.

Another core aspect of the method disclosed herein is a solution for a first network node to be notified of whether, when, and how an AIML model has been verified (e.g., tested and/or validated) by the second network node or by a third network node, and about the result of verification (e.g., testing and/or validation). In cases where the first network node provides the AIML model to the second network node, the first network node can be notified when and how the AIML model provided to the second network node has been verified (e.g., tested and/or validated) by the second network node or by a third network node, and about the result of the said verification (e.g., testing and/or validation).

It needs to be mentioned that the second network node may, upon or without receiving configurations/instructions/semantics according to which the model should be verified, decide to run such verification process independently from any request from the first node and to provide results about the verification to the first network node or to any other external nodes or systems without any previous requests.

### METHOD EXECUTED BY A FIRST NETWORK NODE (TRAINING FUNCTION)

Some embodiments of the current disclosure disclose a method executed by a first network node to enable or control the verification (e.g., testing and/or validation) of an AIML model in a second network node in a radio communication network, the method comprising one or more of the following steps:
Transmitting a FIRST MESSAGE to the second network node, the FIRST MESSAGE comprising configurations/instructions/semantics information for verifying an AI/ML model.
Receiving a SECOND MESSAGE from the second network node, the SECOND MESSAGE comprising a report associated with verifying an AIML model.

In one embodiment, the configurations/instructions/semantics provided to the second network node are intended for verifying that an AI/ML model can perform as per the tested and validated performance at the first network node or at least as per an acceptable performance level.

In one embodiment, the first network node may receive a SECOND MESSAGE from the second network node comprising a report associated with verifying an AIML model based on the configurations/instructions/semantics information received with the FIRST MESSAGE. In this case, the first network node receives a SECOND MESSAGE form the second network node upon transmitting the FIRST MESSAGE to the second network node.

In one embodiment, the first network node may receive a SECOND MESSAGE from the second network node comprising a report associated with verifying an AIML model without prior transmitting a FIRST MESSAGE to the second network node comprising configurations/instructions/semantics information for verifying that an AI/ML model. In this case, the second network node may without previous configurations/instructions from the first network node, run the model verification process and notify the first network node of inconsistencies between the instructions/configurations/semantics relative to the inputs and/or outputs, provided prior to using the AIML model, and the actual availability of the inputs and/or outputs over the connected interfaces to the second network node.

In one embodiment, the first network node may provide, either with the FIRST MESSAGE or with a THIRD MESSAGE, an AIML model to the second network node and the configurations/instructions/semantics information for verifying an AI/ML model associated to the AIML model provided by the first network node.

In one embodiment of the method, the first network node may provide to the second network node, either with the FIRST MESSAGE or with a THIRD MESSAGE, a set of reference data samples which can be used to verify the AIML model. In one example the set of reference data samples can be provided with the FIRST MESSAGE as part of the configuration for verifying an AI/ML model. In another example, the provided reference data samples could be explicitly associated to one or more AIML models.

A description of non-limiting examples of verification of an AIML model that can be configured or requested by the first network node is provided herein.

More detailed embodiments for FIRST MESSAGE

In one embodiment, the configuration for verifying the AIML model may comprise one or more information elements in the group of:

An identity or an identifier of an AIML model to which the configuration for verification is applicable to or associated to.
An indication to verify an AIML model
An instruction to verify an AIML model
A recommendation to verify an AIML model

The configuration provided with the FIRST MESSAGE may further include an indication of at least one network node (e.g., second network node or a third network node) to which the provided configuration is associated to.

In one embodiment, the configuration s/instructions/semantics information for verifying the AIML model may consist of one or more information related to verifying the AIML model in the group of:
[1] One or more conditions or events to be fulfilled for triggering the verification of the AIML model indicated by the first network node
[2] One or more instructions or policies or recommendations related to verification of the AIML model indicated by the first network node.
[3] A request to transmit to the first network node a report comprising information associated to the verification of the AIML model indicated by the first network node.
[4] One or more conditions or events to be fulfilled for transmitting a report to the first network node comprising information associated to the verification of the AIML model indicated by the first network node.
[5] One or more conditions or events to be fulfilled for transmitting/forwarding (to a third network node) the configuration for verifying the AIML model (withholding of the configuration at second network node)
[6] Weight factors for each input needed by the model, namely revealing the importance/priority of each input type with respect to the process of inference carried out by the model
[7] Frequency and/or frequency ranges and/or cumulative amount of samples in a given time window, with which each type of input is assumed to be received in order to allow the model to perform according to its tested performance or according to a sufficiently good performance level established by the first node
[8] Frequency and/or frequency ranges and/or cumulative number of samples in a given time window, with which each type of output is assumed to be generated in order to allow the model to perform according to its tested performance or according to a sufficiently good performance level established by the first node
[9] Semantics of the inputs needed at the model and/or of the outputs generated by the model

### METHOD EXECUTED BY A SECOND NETWORK NODE

Some embodiments of the current disclosure disclose a method executed by a second network node to verify an AIML model provided by a first network node in a radio communication network, the method comprising one or more of the following steps:
Receiving a FIRST MESSAGE from a first network node, the FIRST MESSAGE comprising configurations/instructions/semantics information for verifying that an AI/ML model.
Transmitting a SECOND MESSAGE to the first network node, the SECOND MESSAGE comprising a report associated with verifying an AIML model.

In one embodiment, the second network node may transmit the SECOND MESSAGE to the first network node comprising a report associated with verifying an AIML model based on the configurations/instructions/semantics information received with the FIRST MESSAGE. In this case, the second network node receives a FIRST MESSAGE form the first network prior to transmitting the SECOND MESSAGE to the first network node.

In one embodiment, the second network node may transmit the SECOND MESSAGE to the first network node comprising a report associated with verifying an AIML model without prior receiving a FIRST MESSAGE from the first network node comprising configurations/instructions/semantics information for verifying that an AI/ML model. In this case, the second network node may without previous configurations/instructions from the first network node, run the model verification process and notify the first network node of inconsistencies between the instructions/configurations/semantics relative to the inputs and/or outputs, provided prior to using the AIML model, and the actual availability of the inputs and/or outputs over the connected interfaces to the second network node.

The second network node may signal the result of the verification/testing/validation process to any other external node or system in the network, to enable system diagnostic and system optimization.

In one embodiment, the second network node may receive, either with the FIRST MESSAGE or with a THIRD MESSAGE, an AIML model from the first network node. In this case, the configuration for verifying an AI/ML model provided with the FIRST MESSAGE may be associated to the AIML model provided by the first network node to the second network node.

In one embodiment, the second network node may additionally
Transmit a FOURTH MESSAGE to a third network node comprising at least part of the configurations/instructions/semantics information for verifying an AIML model received by the first network node
Receive a FIFTH MESSAGE from the third network node comprising a report associated to verifying an AIML model based on the configurations/instructions/semantics information received with the FOURTH MESSAGE.

In this case, the second network node may then forward the report received from the third network node to the first network node via the SECOND MESSAGE.

Embodiments for the SECOND MESSAGE

In one embodiment, the report associated to verifying an AIML mode transmitted by the second network node to the first network node with the SECOND MESSAGE may comprise one or more information elements in the group of
An indication indicating that an AIML model has been verified.
An indication indicating whether the verification of the AIML model was successful or unsuccessful.
The type of verification done for the AIML model. Non limiting examples may include testing, validating, evaluating, etc.
An indication or an identity or an identifier of at least a network node that has verified and/or validated the AIML model provided by the first network node. The indicated network node could be the second network node itself or a third network node.
One or more information related to at least a condition or event that triggered the verification of the AIML model (either at the second network node or in a third network node).
   A non-limiting example is model re-training. That is, when the AIML model indicated by the FIRST MESSAGE is re-trained by the second network node or by a third network node
One or more information related to how the AIML model has been verified, and details about the result of verification.
   One or more information related to how the AIML model has been tested, and details about the result of the test.
   One or more information related to how the AIML model has been validated, and details about the result of validation.
An indication of whether the inputs required by the model are sufficiently available and eventually which of such needed inputs are not available or only available in insufficient amounts
An indication of whether the outputs generated by the model can be delivered with the frequency or according to the amounts specified by the configurations/instructions/semantics information received
An indication of whether the semantics of the inputs received via connected interfaces and/or signaled over connected interfaces are in accordance with the configurations/instructions/semantics information received. In addition, a list of specific inputs/outputs for which the semantics are inconsistent and not matching can be signaled
An indication of whether the resources required by the model to be executed are not available at the second network node. In addition, the type of resource not satisfying the model's requirements can be specified

Certain embodiments may provide one or more of the following technical advantage(s). One advantage of the proposed solution is that it enables a first network node, responsible for training an AIML model and providing it to a second network node, to specify whether, when, and how the model can, should, or must be verified by the second network node prior to using the model. This allows the first network node to ensure that the model, for which it is responsible, is correctly set up, applied, or installed by the second network node and works as expected before the second network uses the model, for instance, for inference.

Another advantage of the proposed solution is that it enables a first network node, responsible for training an AIML model and providing it to a second network node, to request and receive an indication from the second network node of whether the second network node has successfully or unsuccessfully verified the model. This allows the first network node to be informed whether the second network node correctly set up, applied, or installed the model, and, in case not, provide, for example, a new model or refined instructions on how to correctly set up, apply, or install the model etc., or apply a different model packaging.

Another advantage of the proposed solution is that it enables a first network node, responsible for training an AIML model and providing it to a second network node, to specify whether, when and how the performance of the model at the second network node should or must be tested/validated prior to using the model. This allows the first network node to ensure that the model, for which it is responsible, performs as expected on the data (locally) available to the second network node. That is, the first network node can ensure that the model meets the performance requirement(s) in the situation/environment present at the second network node, before the model is used, e.g., for inference, without the need to have/access the data available to the second network node.

Another advantage of the proposed solution is that it enables a first network node, responsible for training an AIML model and providing it to a second network node, to request to receive an indication from the second network node of whether the second network node has successfully or unsuccessfully tested/validated the model, i.e., whether the performance on the data (locally) available to the second network met the requirement(s) provided by the first network node. This allows the first network node to be informed whether the model performs as expected in the target environment, and, in case not, provide, e.g., a different model.

Another advantage related to reinforcement learning is how the first network node can test whether certain actions are not, or less likely to be performed in the second node. One can for example train a certain safety shield in RL, where a set of actions should be less likely to be performed. These state-action pairs (reference input/output) could be part of the “testing” a model in the second node. This would ensure that the second node could retrain the model, while still maintaining a certain safety mechanism defined by the first node. One such safety examples is to avoid turn off a certain capacity cell if the load is high in the second network node.

Another advantage is the second network node can perform pruning of the model, if it fulfills certain testing requirements. For example, when the test is based on observed data in the second node, it can use such data to understand how to reduce the model complexity. Moreover, the pruning of models can be seen as an implementation aspect, where a large general static model is defined at a server node, and then each NG-RAN node prunes the model to fit their computational hardware best.

Another advantage of the methods is that the second network node, once it receives configurations/instructions/semantics information on how to verify the model from the first network node, can autonomously determine whether to verify the model and it can autonomously determine to signal the results of the verification process to the first network node or to any other node or systems in the network. This allows the second network node to identify and bring to light issues that may arise from inadequate model requirements or inconsistent information available at the second node with respect to information needed by the model.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates the Functional Framework for RAN Intelligence comprised in R3-216278;

FIG. 2 illustrates one example of a cellular communications system in which embodiments of the present disclosure may be implemented;

FIG. 3 illustrates a wireless communication system represented as a 5G network architecture composed of core Network Functions (NFs), where interaction between any two NFs is represented by a point-to-point reference point/interface;

FIG. 4 illustrates a 5G network architecture using service-based interfaces between the NFs in the CP, instead of the point-to-point reference points/interfaces used in the 5G network architecture of FIG. 3;

FIG. 5 shows an illustration of the method where the first network node transmits a FIRST MESSAGE to a second network node, according to some embodiments of the present disclosure;

FIG. 6 shows an illustration of the method where the first network node receives a SECOND MESSAGE from the second network node, according to some embodiments of the present disclosure;

FIG. 7 shows an illustration of the method wherein the first network node provides an AIML model to the second network node to which the configuration for verification is associated, according to some embodiments of the present disclosure;

FIG. 8 shows an example wherein the first network node provides an AIML model to the second network node, according to some embodiments of the present disclosure;

FIG. 9 illustrates an embodiment where the second network node transmits and receives additional messages, according to some embodiments of the present disclosure;

FIG. 10 shows an example of the method wherein the first network node 500 is an Operation And Maintenance (OAM) or a Service and Management Orchestration (SMO) node, while the second network node is a RAN node, according to some embodiments of the present disclosure;

FIG. 11 illustrates a non-limiting example of the method wherein the first network node is a gNB-CU-CP and the second network node is a gNB-DU, according to some embodiments of the present disclosure;

FIG. 12 shows a non-limiting example of how the method can be mapped to the AIML functional framework for the NG-RAN and E-UTRAN system defined by 3GPP, according to some embodiments of the present disclosure;

FIG. 13 shows a non-limiting example of such scenario where the first network node is an OAM node, while the second and third network node belong to an NG-RAN node with split architecture, such as a gNB-CU-CP and a gNB-DU, respectively, according to some embodiments of the present disclosure;

FIG. 14 is a schematic block diagram of a radio access node according to some embodiments of the present disclosure;

FIG. 15 is a schematic block diagram that illustrates a virtualized embodiment of the radio access node according to some embodiments of the present disclosure;

FIG. 16 is a schematic block diagram of the radio access node according to some other embodiments of the present disclosure;

FIG. 17 is a schematic block diagram of a wireless communication device 1700 according to some embodiments of the present disclosure;

FIG. 18 is a schematic block diagram of the wireless communication device according to some other embodiments of the present disclosure;

FIG. 19 illustrates a communication system includes a telecommunication network, such as a 3GPP-type cellular network, which comprises an access network, such as a RAN, and a core network, according to some embodiments of the present disclosure;

FIG. 20 illustrates a communication system, a host computer comprises hardware including a communication interface configured to set up and maintain a wired or wireless connection with an interface of a different communication device of the communication system, according to some embodiments of the present disclosure;

FIG. 21 is a flowchart illustrating a method implemented in a communication system, in accordance with one embodiment;

FIG. 22 is a flowchart illustrating a method implemented in a communication system, in accordance with one embodiment;

FIG. 23 is a flowchart illustrating a method implemented in a communication system, in accordance with one embodiment; and

FIG. 24 is a flowchart illustrating a method implemented in a communication system, in accordance with one embodiment.

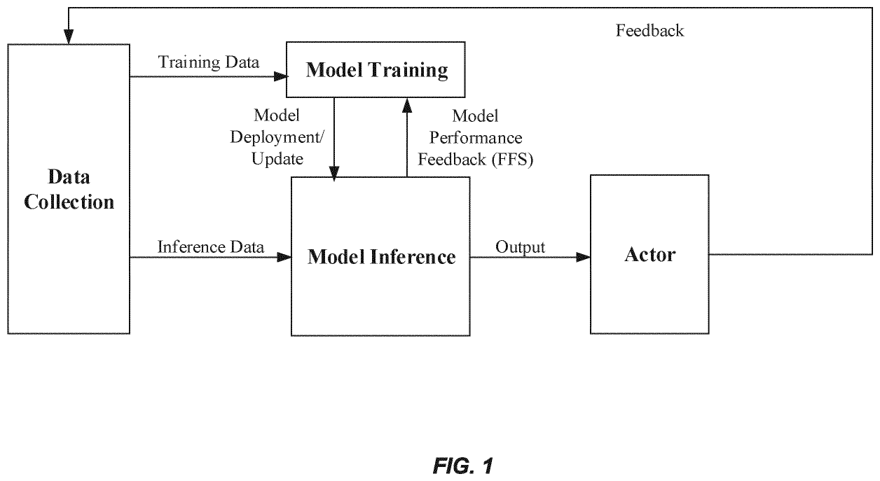

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (loT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may a part of the gNB transmitting and receiving radio signals to/from UE according to physical layer properties and parameters inherent to that element. In some embodiments, in Multiple TRP (multi-TRP) operation, a serving cell can schedule UE from two TRPs, providing better Physical Downlink Shared Channel (PDSCH) coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, UE is scheduled by the same DCI for both TRPs and in multi-DCI mode, UE is scheduled by independent DCIs from each TRP.

In some embodiments, a set Transmission Points (TPs) is a set of geographically co-located transmit antennas (e.g., an antenna array (with one or more antenna elements)) for one cell, part of one cell or one Positioning Reference Signal (PRS)-only TP. TPs can include base station (eNB) antennas, Remote Radio Heads (RRHs), a remote antenna of a base station, an antenna of a PRS-only TP, etc. One cell can be formed by one or multiple TPs. For a homogeneous deployment, each TP may correspond to one cell.

In some embodiments, a set of TRPs is a set of geographically co-located antennas (e.g., an antenna array (with one or more antenna elements)) supporting TP and/or Reception Point (RP) functionality.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

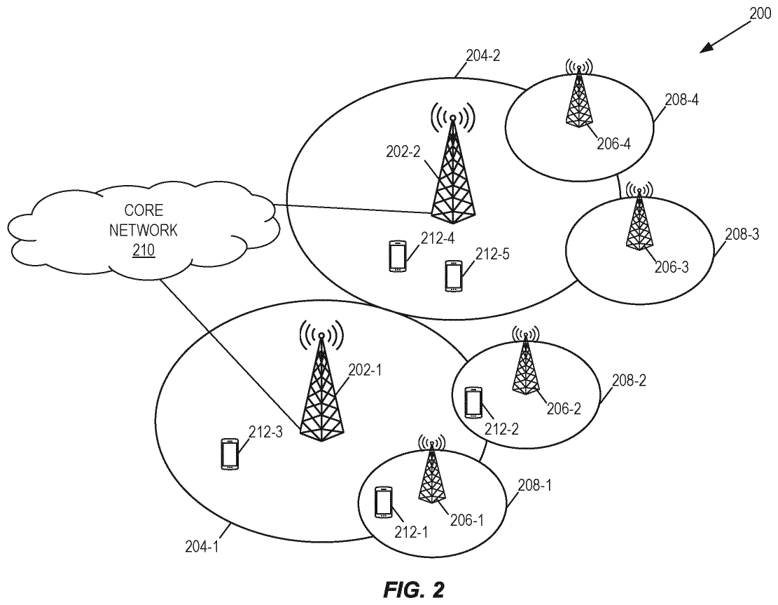

FIG. 2 illustrates one example of a cellular communications system 200 in which embodiments of the present disclosure may be implemented. In the embodiments described herein, the cellular communications system 200 is a 5G system (5GS) including a Next Generation RAN (NG-RAN) and a 5G Core (5GC). In this example, the RAN includes base stations 202-1 and 202-2, which in the 5GS include NR base stations (gNBs) and optionally next generation eNBs (ng-eNBs) (e.g., LTE RAN nodes connected to the 5GC), controlling corresponding (macro) cells 204-1 and 204-2. The base stations 202-1 and 202-2 are generally referred to herein collectively as base stations 202 and individually as base station 202. Likewise, the (macro) cells 204-1 and 204-2 are generally referred to herein collectively as (macro) cells 204 and individually as (macro) cell 204. The RAN may also include a number of low power nodes 206-1 through 206-4 controlling corresponding small cells 208-1 through 208-4. The low power nodes 206-1 through 206-4 can be small base stations (such as pico or femto base stations) or RRHs, or the like. Notably, while not illustrated, one or more of the small cells 208-1 through 208-4 may alternatively be provided by the base stations 202. The low power nodes 206-1 through 206-4 are generally referred to herein collectively as low power nodes 206 and individually as low power node 206. Likewise, the small cells 208-1 through 208-4 are generally referred to herein collectively as small cells 208 and individually as small cell 208. The cellular communications system 200 also includes a core network 210, which in the 5G System (5GS) is referred to as the 5GC. The base stations 202 (and optionally the low power nodes 206) are connected to the core network 210.

The base stations 202 and the low power nodes 206 provide service to wireless communication devices 212-1 through 212-5 in the corresponding cells 204 and 208. The wireless communication devices 212-1 through 212-5 are generally referred to herein collectively as wireless communication devices 212 and individually as wireless communication device 212. In the following description, the wireless communication devices 212 are oftentimes UEs, but the present disclosure is not limited thereto.

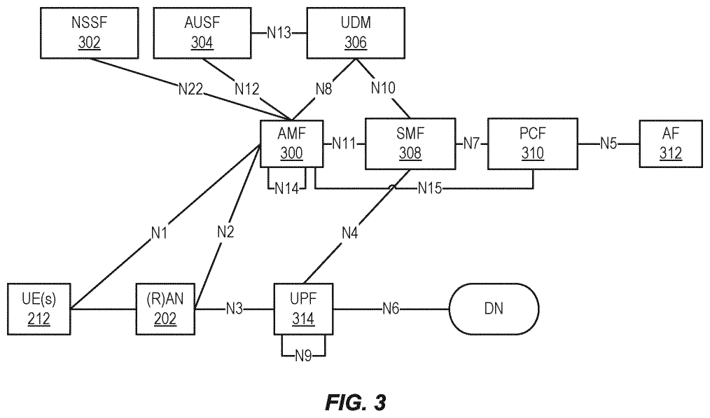

FIG. 3 illustrates a wireless communication system represented as a 5G network architecture composed of core Network Functions (NFs), where interaction between any two NFs is represented by a point-to-point reference point/interface. FIG. 3 can be viewed as one particular implementation of the system 200 of FIG. 2.

Seen from the access side the 5G network architecture shown in FIG. 3 comprises a plurality of UEs 212 connected to either a RAN 202 or an Access Network (AN) as well as an AMF 300. Typically, the R (AN) 202 comprises base stations, e.g., such as eNBs or gNBs or similar. Seen from the core network side, the 5GC NFs shown in FIG. 3 include a NSSF 302, an AUSF 304, a UDM 306, the AMF 300, a SMF 308, a PCF 310, and an Application Function (AF) 312.

Reference point representations of the 5G network architecture are used to develop detailed call flows in the normative standardization. The N1 reference point is defined to carry signaling between the UE 212 and AMF 300. The reference points for connecting between the AN 202 and AMF 300 and between the AN 202 and UPF 314 are defined as N2 and N3, respectively. There is a reference point, N11, between the AMF 300 and SMF 308, which implies that the SMF 308 is at least partly controlled by the AMF 300. N4 is used by the SMF 308 and UPF 314 so that the UPF 314 can be set using the control signal generated by the SMF 308, and the UPF 314 can report its state to the SMF 308. N9 is the reference point for the connection between different UPFs 314, and N14 is the reference point connecting between different AMFs 300, respectively. N15 and N7 are defined since the PCF 310 applies policy to the AMF 300 and SMF 308, respectively. N12 is required for the AMF 300 to perform authentication of the UE 212. N8 and N10 are defined because the subscription data of the UE 212 is required for the AMF 300 and SMF 308.

The 5GC network aims at separating UP and CP. The UP carries user traffic while the CP carries signaling in the network. In FIG. 3, the UPF 314 is in the UP and all other NFs, i.e., the AMF 300, SMF 308, PCF 310, AF 312, NSSF 302, AUSF 304, and UDM 306, are in the CP. Separating the UP and CP guarantees each plane resource to be scaled independently. It also allows UPFs to be deployed separately from CP functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF 300 and SMF 308 are independent functions in the CP. Separated AMF 300 and SMF 308 allow independent evolution and scaling. Other CP functions like the PCF 310 and AUSF 304 can be separated as shown in FIG. 3. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

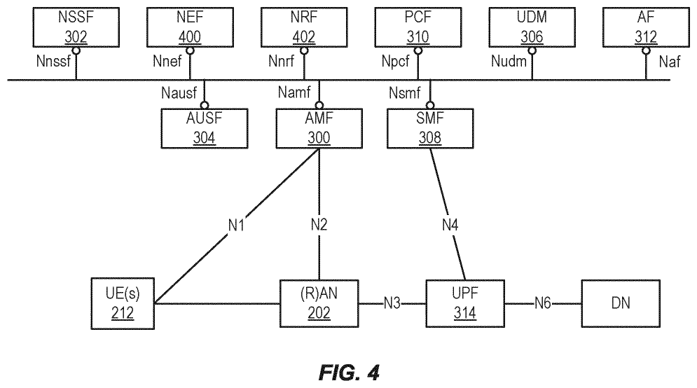

FIG. 4 illustrates a 5G network architecture using service-based interfaces between the NFs in the CP, instead of the point-to-point reference points/interfaces used in the 5G network architecture of FIG. 3. However, the NFs described above with reference to FIG. 3 correspond to the NFs shown in FIG. 4. The service(s) etc. that a NF provides to other authorized NFs can be exposed to the authorized NFs through the service-based interface. In FIG. 4 the service-based interfaces are indicated by the letter “N” followed by the name of the NF, e.g., Namf for the service-based interface of the AMF 300 and Nsmf for the service-based interface of the SMF 308, etc. The NEF 400 and the NRF 402 in FIG. 4 are not shown in FIG. 3 discussed above. However, it should be clarified that all NFs depicted in FIG. 3 can interact with the NEF 400 and the NRF 402 of FIG. 4 as necessary, though not explicitly indicated in FIG. 3.

Some properties of the NFs shown in FIGS. 3 and 4 may be described in the following manner. The AMF 300 provides UE-based authentication, authorization, mobility management, etc. A UE 212 even using multiple access technologies is basically connected to a single AMF 300 because the AMF 300 is independent of the access technologies. The SMF 308 is responsible for session management and allocates Internet Protocol (IP) addresses to UEs. It also selects and controls the UPF 314 for data transfer. If a UE 212 has multiple sessions, different SMFs 308 may be allocated to each session to manage them individually and possibly provide different functionalities per session. The AF 312 provides information on the packet flow to the PCF 310 responsible for policy control in order to support QoS. Based on the information, the PCF 310 determines policies about mobility and session management to make the AMF 300 and SMF 308 operate properly. The AUSF 304 supports authentication function for UEs or similar and thus stores data for authentication of UEs or similar while the UDM 306 stores subscription data of the UE 212. The Data Network (DN), not part of the 5GC network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

For the proposed solution, the following is considered:
a network node can be a RAN node, a Core Network node, an OAM, an SMO, a Network Management System (NMS), a Non-Real Time RAN Intelligent Controller (Non-RT RIC), a Real-Time RAN Intelligent Controller (RT-RIC), a gNB, eNB, en-gNB, ng-eNB, gNB-CU, gNB-CU-CP, gNB-CU-UP, eNB-CU, eNB-CU-CP, eNB-CU-UP, IAB-node, IAB-donor DU, IAB-donor-CU, IAB-DU, IAB-MT, O-CU, O-CU-CP, O-CU-UP, O-DU, O-RU, O-eNB.
The terms model training, model optimizing, model optimization, model updating are herein used interchangeably with the same meaning unless explicitly specified otherwise.
The terms model changing, modify or similar are herein used interchangeably with the same meaning unless explicitly specified otherwise. In particular, they refer to the fact that the type, structure, parameters, connectivity of an AIML model may have changed compared to a previous format/configuration of the AIML model.
The terms AI/ML model, AI/ML policy, AI/ML algorithm, as well the terms, model, policy or algorithm are herein used interchangeably with the same meaning unless explicitly specified otherwise.

References to “network nodes” herein should be understood such that a network node may be a physical node or a function or logical entity of any kind, e.g., a software entity implemented in a data center or a cloud, e.g., using one or more virtual machines, and two network nodes may well be implemented as logical software entities in the same data center or cloud.

There currently exist certain challenges. Using an AIML technology in communication networks, such as Radio Access Network (RAN), it is possible that an AIML model is trained by a first network node and used by other network nodes. This is the case, for instance, when a node hosting a model training function creates a model and provides it to other network nodes (e.g., RAN nodes), which can then use that model for inference and optimize the network performance according to the purpose of the model. As communication networks are often multi-organization (e.g., multi-vendor) systems, it is not precluded that the first network node and the other network nodes are, e.g., from different vendors.

One problem with existing technology is that a first network node cannot verify whether an AIML model created by the first network node and provided to another network node works as expected when being used by the other network node, meaning that it is correctly set up, applied, or installed by the other network node.
In one example, the first network node saves and transmits the model as serialized file associated to a certain AI/ML framework (e.g., TensorFlow). In this example, a problem may or may not occur when the software library versions at the first network node and the other network node are not identical, meaning that the model is trained and saved with one library version and loaded and used with another library version. One potential problem is that the model generates false or otherwise inaccurate outputs.
In another example, the first network node trains a model for a use case that operates on a very fast time scale and thus requires a very low execution (i.e., inference) time. In this case, a problem occurs if, for example, the hardware capabilities of the other network node or the compute resources allocated by the other network node for the execution of the model do not allow the other network node to meet the time requirement of the use case.
In another example, the model or models transmitted by the node training the model to the node executing the model are too large in size with respect to the memory available at the receiving node. This would require a “reduction” in size of the model. If such reduction is applied, the model may perform in a way different from what the node training the model has tested and validated the model.

Another problem with existing technology is that a first network node cannot verify whether an AIML model created by the first network node and provided to another network node achieves the expected performance when being used by the other network node, e.g., when being used on local data which is not available at the first network node.
In one example, the first network node trains the model on data that is not representative for the (local) data available at the other network node. This can constitute a problem because the model is not suitable for the situation/environment at the other network node, and is likely going to perform worse than expected, i.e., worse than what model validation at the first node, e.g., using a test dataset, suggested.

Another problem is that the model developed by the first network node may rely on certain inputs that may not be available at the node receiving the model or that may be available with a number of samples that is not sufficient to allow the model to work properly. This may occur for example if the node training the model has allocated a high weight to certain inputs, but where availability of such inputs with the same weight as determined in the node training the model has not been verified at the node receiving the model.

Another problem is that the number of inputs and/or outputs needed and/or generated by the model trained by the first node cannot be received/delivered due to network interface problems. For example, network interfaces connecting the node receiving the model to other network nodes may not be sufficiently capable to receive and transmit the required inputs and/or the generated outputs. This would imply either starving the model of its needed inputs or not delivering the outputs produced at the required frequency.

Another problem is that the model developed by the node hosting the training function may use inputs and outputs data following semantics that are different from the semantics of the same or similar information elements received and/or transmitted over the interfaces connected to the node receiving the model. As one example, the node hosting the model training function may use as training data information on resource utilization at a given cell1, as a percentage of the capacity of a reference cell2 different from cell1. If the node receiving the model uses as inputs to the model a resource utilization parameter which is the percentage of the overall resources available at Cell1, then the training data and the inference inputs are different and the model will not perform as per testing and validation carried out by the node training the model.

The methods provided in the current disclosure are independent with respect to specific AI/ML model types or learning problems/setting (e.g., supervised learning, unsupervised learning, reinforcement learning, hybrid learning, centralized learning, federated learning, distributed learning, . . . ).

Non limiting examples of AI/ML algorithms may include supervised learning algorithms, deep learning algorithms, reinforcement learning type of algorithms (such as DQN, A2C, A3C, etc.), contextual multi-armed bandit algorithms, autoregression algorithms, etc., or combinations thereof.

Such algorithms may exploit functional approximation models, hereafter referred to as AI/ML models, such as neural networks (e.g., feedforward neural networks, deep neural networks, recurrent neural networks, convolutional neural networks, etc.).

Examples of reinforcement learning algorithms may include deep reinforcement learning (such as deep Q-network (DQN), proximal policy optimization (PPO), double Q-learning), actor-critic algorithms (such as Advantage actor-critic algorithms, e.g., A2C or A3C, actor-critic with experience replay, etc.), policy gradient algorithms, off-policy learning algorithms, etc.

### Methods Related to a First Network Node

Some of the embodiments of the current disclosure include a method for a first network node to enable and/or control whether, when, and how an AIML model (possibly trained by the first network node) provided to a second network node could, should, or must be verified (e.g., tested and/or validated) by the second network node or by a third network node, and whether, when, and how the first network node must be notified about the result of the said verification (e.g., testing and/or validation).

Another core aspect of the method disclosed herein is a solution for a first network node to be notified of whether, when, and how an AIML model provided by the first network node to a second network node has been verified (e.g., tested and/or validated) by the second network node or by a third network node, and about the result of verification (e.g., testing and/or validation).

Some embodiments of the current disclosure include a method executed by a first network node to enable or control the verification (e.g., testing and/or validation) of an AIML model in a second network node in a radio communication network, the method comprising the one or more of the following steps:
Transmitting a FIRST MESSAGE to the second network node, the FIRST MESSAGE comprising configurations/instructions/semantics information for verifying an AI/ML model.
Receiving a SECOND MESSAGE from the second network node, the SECOND MESSAGE comprising a report associated with verifying an AIML model.

In one example, the configurations/instructions/semantics provided to the second network node are intended for verifying that an AI/ML model can perform as per the tested and validated performance at the first network node or at least as per an acceptable performance level.

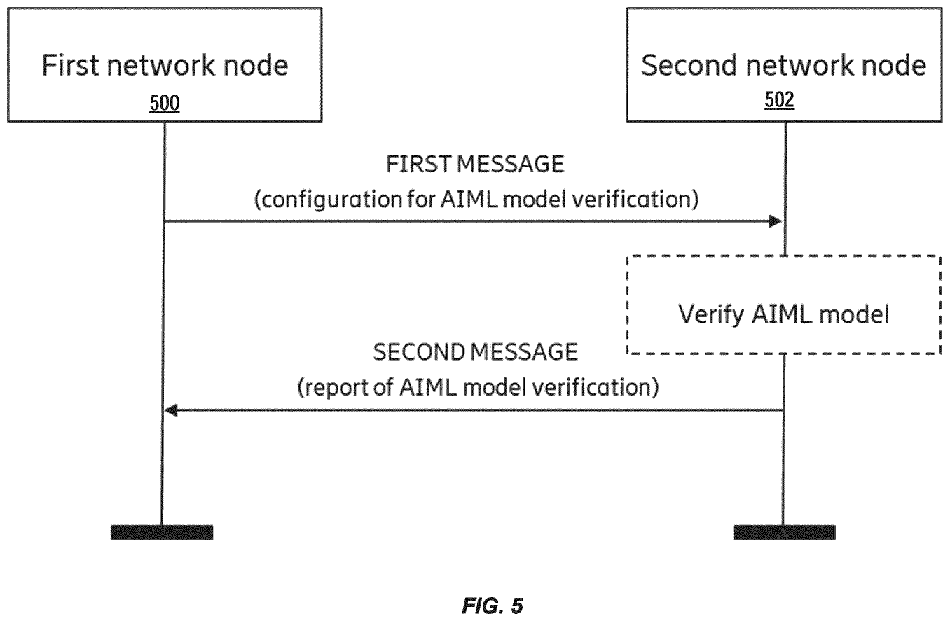

In one embodiment, illustrated in FIG. 5, the first network node 500 may first transmit a FIRST

MESSAGE to the second network node 502 comprising configurations/instructions/semantics information for verifying an AI/ML model, and receive the SECOND MESSAGE from the second network node 502. In this case, the report associated with verifying an AIML model received with the SECOND MESSAGE may be based on the configurations/instructions/semantics information provided with the FIRST MESSAGE.

FIG. 5 shows an illustration of the method where the first network node 500 transmits a FIRST MESSAGE to a second network node 502 comprising a configuration for verifying an AI/ML model and optionally receives a SECOND MESSAGE comprising a report associated to verifying an AIML model.

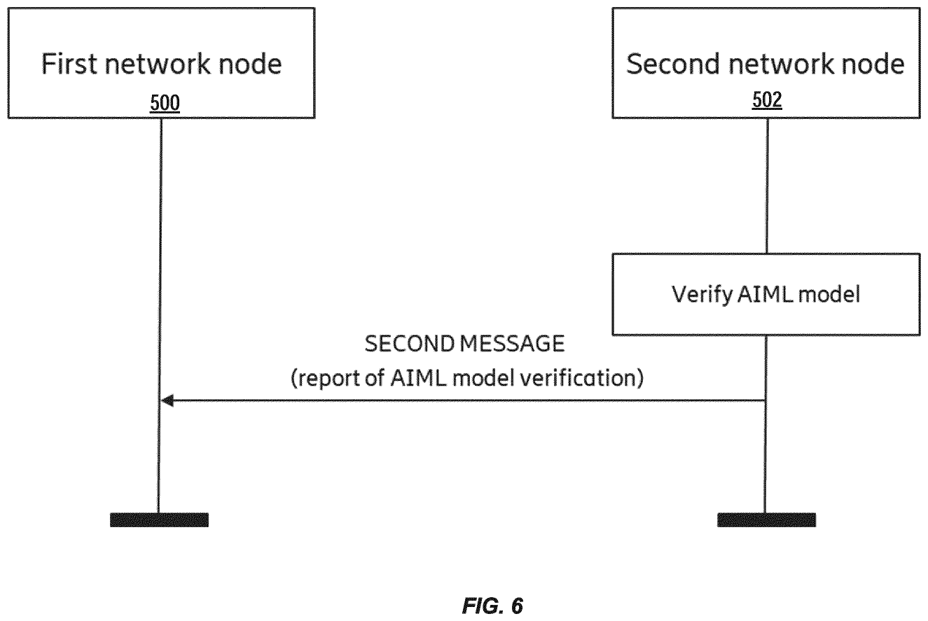

In one embodiment, illustrated in FIG. 6, the first network node 500 may receive a SECOND MESSAGE from the second network node 502 comprising a report associated with verifying an AIML model without prior transmitting a FIRST MESSAGE to the second network node 502 comprising configurations/instructions/semantics information for verifying an AI/ML model. In this case, the second network node 502 may without previous configurations/instructions from the first network node 500, run the model verification process and notify the first network node 500 of inconsistencies between the instructions/configurations/semantics relative to the inputs and/or outputs, provided prior to using the AIML model, and the actual availability of the inputs and/or outputs over the connected interfaces to the second network node 502.

FIG. 6 shows an illustration of the method where the first network node 500 receives a SECOND MESSAGE from the second network node 502 comprising a report associated to verifying an AIML model without prior transmitting a FIRST MESSAGE to the second network node 502 comprising configurations/instructions/semantics intended for verifying an AI/ML model.

In one embodiment, the first network node 500 may provide, either with the FIRST MESSAGE or with a THIRD MESSAGE, an AIML model to the second network node 502. In this case, the configuration for verifying an AI/ML model provided with the FIRST MESSAGE may be associated to the AIML model provided by the first network node 500 to the second network node 502. In one example, the FIRST MESSAGE may provide to the second network node 502 both an AIML model and a configuration to verify the AIML model.

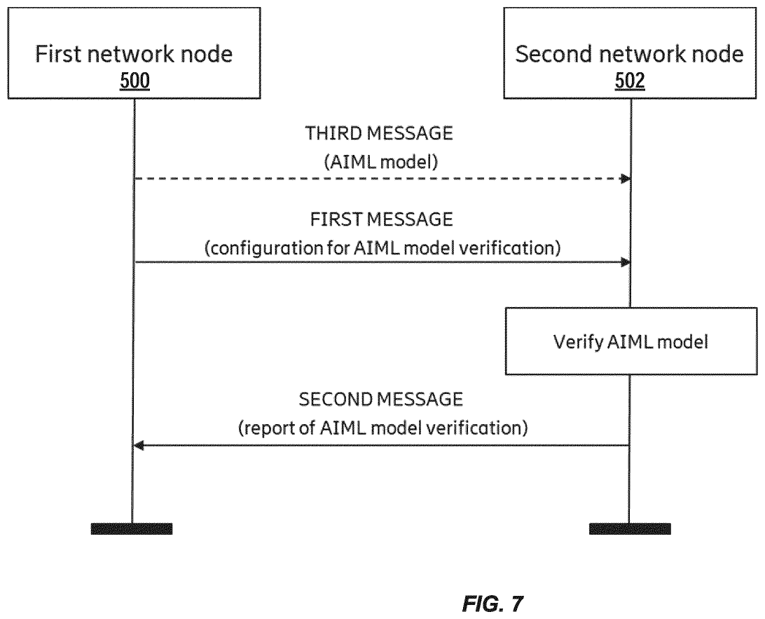

FIG. 7 shows an illustration of the method wherein the first network node 500 provides an AIML model to the second network node 502 to which the configuration for verification is associated. In this non-limiting example, the AIML model is provided with a THIRD MESSAGE prior to transmitting the FIRST MESSAGE.

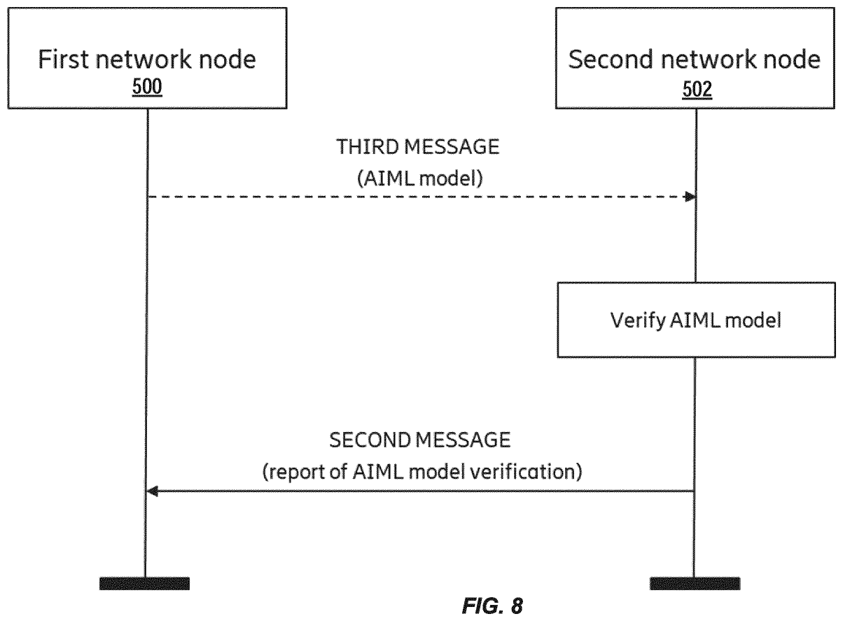

In a possible example of this embodiment, illustrated in FIG. 8, the first network node 500 provides an AIML model to the second network node 502 with the THIRD MESSAGE and receives a report from the second network node 502 associated to verifying the AIML model with the SECOND MESSAGE. In this example, however, the first network node 500 does not transmit the FIRST MESSAGE to the second network node 502 comprising configurations/instructions/semantics intended for verifying an AI/ML model. Therefore, upon receiving an AIML model from the first network node 500, the second network node 502 may without previous configurations/instructions from the first network node 500, run the model verification process and notify the first network node 500 of inconsistencies between the instructions/configurations/semantics relative to the inputs and/or outputs, provided prior to using the AIML model, and the actual availability of the inputs and/or outputs over the connected interfaces to the second network node 502.

FIG. 8 shows an example wherein the first network node 500 provides an AIML model to the second network node 502 with the THIRD MESSAGE and receives a SECOND MESSAGE from the second network node 502 comprising a report associated to verifying the AIML model without. In this example, the first network node 500 does not transmit the FIRST MESSAGE to the second network node 502 comprising configurations/instructions/semantics intended for verifying an AI/ML model

In one embodiment of the method, the first network node 500 may provide to the second network node 502, either with the FIRST MESSAGE or with a THIRD MESSAGE, a set of reference data samples, which can be used to verify the AIML model. In one example the set of reference data samples can be provided with the FIRST MESSAGE as part of the configuration for verifying an AI/ML model. In another example, the first network node 500 may provide, either with the FIRST MESSAGE or with a THIRD MESSAGE, both the AIML model and a set of reference data samples that can be used to verify the AIML model. In another example, the provided reference data samples could be explicitly associated to one or more AIML models.

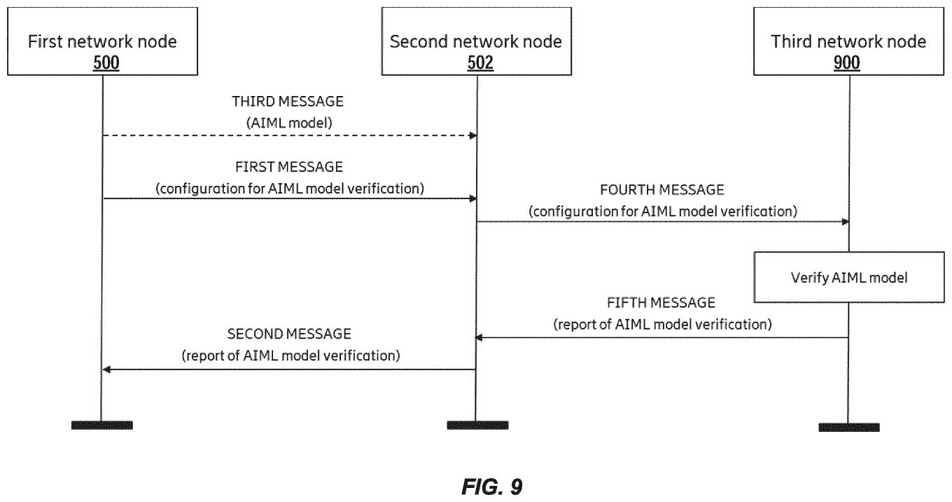

In one example, the reference set of data samples for verifying the AIML model could consist of a set of reference input-output pairs, where each reference output value represents that output that is expected to obtain for the corresponding reference input data when provided to the model for verification. Sometimes such reference output value is also called ground truth. After setting up, applying, installing, or otherwise instantiating the AIML model, the second network node 502 can input the reference inputs to the AIML model and compare the produced outputs to the reference outputs, and thereby test if the AIML model was correctly set up, secured, applied, installed, or instantiated. It can verify that the AIML model functions/performs as intended if the produced outputs are equal to the reference outputs. Therefore, this has the advantage of allowing the second network node 502 or a third network node (see, e.g., FIG. 9) to verify whether an AIML model originally trained by another network node, such as the first network node 500, performs as expected under a controlled set of data.

In another example, the reference set of data samples for verifying the AIML model could consist of reference state-action pairs, wherein the reference action represents either the expected output of the model or the decision of an AIML algorithm using the AIML model, when feeding the AIML model with the reference state.

In another example, the reference set of data samples for verifying the AIML model could be used by the second network node 502 (or by a third network node) to test or validate an AIML model provided by the first network node 500 in case the second network node 502 (or a third network node) determines to re-train the AIML model. As such, a network node that re-trains an AIML model provided by the first network node 500 could determine whether the re-trained model performs as expected or within an acceptable range of value.

In one embodiment of the method, the first network node 500 may provide, either with the FIRST MESSAGE or with a THIRD MESSAGE, indications related to timing requirements (e.g., associated to a use case) and/or required/minimum/recommended hardware capabilities or compute resources for the execution of the model.

In one embodiment of the method, the first network node 500 may provide, either with the FIRST MESSAGE or with a THIRD MESSAGE, indications related to security requirements to be supported/met by the second network node 502 in relation to the AIML model and associated information (e.g., support for security activation, methods procedures and algorithms for authentication, encryption, integrity, confidentiality).

### Embodiments Related to FIRST MESSAGE

In the context of some embodiments, verifying an AIML model can comprise one or more of the following operations:
Verifying that the AIML model can be set up, applied, or installed by a network node, i.e., the AIML model and associated instructions or policies on how to set up, secure, apply, or install the AIML model are exhaustive, understood, and executable by the network node.
Testing whether the AIML model was correctly set up, secured, applied, or installed by a network node, e.g., by testing whether the AIML model (precisely) reproduces given reference outputs for given reference inputs. Testing whether the execution of the AIML model (i.e., inference) at a network node meets the given execution time requirement.
Validating the performance of the given AIML model on (e.g., local) data available at a network node, and, optionally, evaluating whether the determined performance meets the given performance requirement(s) and how much the output generated by the given AIML model differs from the ground truth.
Evaluating to what extent a re-trained or otherwise modified AIML model deviates from the previous given AIML model, e.g., by evaluating to what extent the AIML model can reproduce given reference outputs for given reference inputs, or how much the outputs generated by the modified AIML model differ from the reference outputs.
Validating the performance of a re-trained or otherwise modified AIML model on (e.g., local) data available at a network node, and, optionally, evaluating whether the determined performance still meets the given performance requirement(s) and how much the output generated by the re-trained or otherwise modified AIML model differs from the ground truth.
Validating whether the hardware capabilities or the compute resources allocated by the second network node 502 for the execution of the model allows to meet the time requirements (e.g., associated to a use case)
Validating whether the security requirements associated to the AIML model can be met.

In one embodiment, the configuration for verifying the AIML model may comprise one or more information elements in the group of:
An identity or an identifier of an AIML model to which the configuration for verification is applicable to or associated to.
An indication to verify an AIML model
An instruction to verify an AIML model
A recommendation to verify an AIML model

Therefore, the first network node 500 may indicate to the second network node 502 which AIML model should or could be verified. In addition, the first network node 500 may indicate or recommend or instruct to the second network node 502 the verification of an AIML model. According to other embodiments, the first network node 500 may further specify that verifying the indicated AIML model may consist in testing the performance of the AIML model, for instance, according to or with respect to a reference dataset (e.g., a reference set of input-output values). In another example, the first network node 500 specifies that verifying the indicated AIML model may consist in validating the performance of the AIML model with respect to one or more hyperparameters of the AIML model.

In one embodiment of the method, the configuration for verifying the AIML model may comprise an identity or an identifier of at least a network node to which the configuration for verifying the AIML model is addressed to. When such information is not provided in the configuration, or when the configuration comprises the identity or an identifier of the second network node 502, the second network node 502 is responsible for the verification of the AIML model indicated by the first network node 500. In another example, the configuration for verifying an AIML model may comprise the identity or an identifier of a third network node. In this case, the second network node 502 may not be responsible for verifying the AIML model indicated by the first network node 500, but could, for instance forward all or part of the configuration for verifying an AIML model to the indicated third network node. A more detailed description of this embodiment is described herein.

In a variant of the method, the configuration for verifying the AIML may comprise an identity or an identifier of a third network node to which the configuration for verifying the AIML model is addressed to, and conditions or events to be fulfilled/verified at the second network node 502 in order for the second network node 502 to forward to the indicated third network node all or part of the configuration for verifying the AIML model (e.g., the first network node 500 requests the second network node 502 to withhold the configuration until an indication is received from the third network node).

In one embodiment of the method, the configuration for verifying the AIML model, one or more information related to verifying the AIML model in the group of:
[1] One or more conditions or events to be fulfilled for triggering the verification of the AIML model indicated by the first network node 500
[2] One or more instructions or policies or recommendations related to verification of the AIML model indicated by the first network node 500.
[3] A request to transmit to the first network node 500 a report comprising information associated to the verification of the AIML model indicated by the first network node 500.
   Simple case: just an indication that the model has been verified (and by which network node)
   The first network node 500 may further request information related to verification and/or validation of the AIML model, e.g., about the result of the verification.
[4] One or more conditions or events to be fulfilled for transmitting a report to the first network node 500 comprising information associated to the verification of the AIML model indicated by the first network node 500.
[5] One or more conditions or events to be fulfilled for transmitting/forwarding (to a third network node) the configuration for verifying the AIML model (withholding of the configuration at second network node 502)
[6] Weight factors for each input needed by the model, namely revealing the importance/priority of each input type with respect to the process of inference carried out by the model
[7] Frequency and/or frequency ranges and/or cumulative amount of samples in a given time window, with which each type of input is assumed to be received in order to allow the model to perform according to its tested performance or according to a sufficiently good performance level established by the first node
[8] Frequency and/or frequency ranges and/or cumulative number of samples in a given time window, with which each type of output is assumed to be generated in order to allow the model to perform according to its tested performance or according to a sufficiently good performance level established by the first node
[9] Semantics of the inputs needed at the model and/or of the outputs generated by the model

A detailed description for [1]-[9] is provided in what follows.

In one embodiment, the [1] conditions or events to be fulfilled for triggering the verification of the AIML model indicated by the first network node 500 may comprise one or more of:

If the indicated AIML model has been re-trained or otherwise modified (by the second network node 502 or by a third network node)
If the performance of a radio feature dependent on the AIML model degrades below a certain threshold
If a time X has passed or if the AIML model has been used for inference N times since the last verification of the AIML model (periodical verification)
If the model parameters of the re-trained AIML model differ from the model parameters of the AIML model provided by the first network node 500 by at least a certain threshold
If the model parameters of the re-trained AIML model differ from the model parameters of the previous AIML model by at least a certain threshold
If the hyperparameters of the modified AIML model differ from the hyperparameters of the AIML model provided by the first network node 500
If the hyperparameters of the modified AIML model differ from the hyperparameters of the previous AIML model
If the distribution of one or more data element used as input to the model changes. Non limiting examples may comprise:
   If the average/mean, max/min, quantiles, or other statistical values of at least one input feature deviates from a reference value. For instance, if the average value increases above a reference value for more than a threshold or if the average value decreases below a reference value for more than a threshold
   If the standard deviation or the variance of at least one input feature increases above a reference value for more than a threshold value
   If a Kullback-Leibler (KL) divergence test, a Kolmogorov-Smirnov (KS) test and/or a chi-square test indicate a change in the distribution of one or more input feature by more than a threshold value
If the environment in which the AIML model operates changes. Such changes may constitute of:
   Changes in the capabilities of the second network node 502 that may condition the functioning of the AIML model, e.g., changes in hardware capabilities or compute resources (e.g., processing power, memory) available or allocated for the execution of the AIML model
If the second network node 502 has provided the first network node 500 indication(s) indicating that the environment in which the AIML model operates has changed (e.g., capabilities of the second network node 502 or the third network node have changed)

In one embodiment, the [2] instructions or policies or recommendations related to verification of the AIML model indicated by the first network node 500 may comprise one or more of:
Type of performance metrics to be verified or evaluated
   Classification: Accuracy, Precision, Recall/Sensitivity, Specificity, F1 score
   Regression: Mean Absolute Error (MAE), Mean Square Error (MSE), Root Mean Square Error (RMSE), Coefficient of Determination (i.e., R-squared), adjusted R-squared
   Online iterative optimization: Dispersion, risk
Type of verification required (testing, validation, evaluation, . . . ). In some cases, different types of verification methods could be requited or associated to different performance metrics (as listed above)
   Verifying that the AIML model and instructions or policies on how to set up, secure, apply, or install the AIML model are exhaustive, comprehensible, and executable
   Verifying that the AIML model was correctly set up, secured, applied, or installed by verifying that the AIML model precisely reproduces given reference outputs for given reference inputs (i.e., deviations between produced outputs and reference outputs within certain boundaries accounting for calculation inaccuracies, rounding errors, etc.)
   Evaluating to what extent a re-trained or otherwise modified AIML model deviates from the given AIML model by evaluating to what extent the AIML model reproduces given reference outputs for given reference inputs, i.e., evaluating how much the outputs produced by modified AIML model differ from the reference outputs
   Verifying that the execution of the AIML model (i.e., inference) meets the given execution time requirement(s) by verifying that the average and/or maximum time for inference is/are below (a) specified threshold(s) for a certain test/verification dataset
   Validating the performance of the AIML model on available (e.g., local) data for one or more of the indicated performance metrics
   Evaluating whether the performance of the AIML model on available (e.g., local) data meets the given performance requirement(s) with respect to one or more of the indicated performance metrics
   Validating the actions taken when feeding in a certain model input (state). For example, evaluating that an action is not taken that violates a certain safety mechanism. One example is that it does not deactivate a certain capacity cell at high load. Another example could comprise that the antennas are not directed towards the sky, or towards a certain geographical area (e.g., towards an area with a lot of capacity cells, since it will cause unnecessary interference)

In one embodiment, the [3] request to transmit to the first network node 500 a report comprising information associated to the verification of the AIML model indicated by the first network node 500 may comprise one or more of:
An indication of whether the verification of the AIML model and instructions or policies on how to set up, secure, apply, or install the AIML model are exhaustive, comprehensible, and executable. If not, an indication of why the said verification was unsuccessful, for example, a certain software library or version of a certain software library for AI/ML (e.g., TensorFlow) is not available or the execution of Docker container images or other OCI-compliant container images is not possible or otherwise limited
An indication of whether the verification of the AIML model using the given set of reference data samples associated with the AIML model was successful or unsuccessful. If unsuccessful, an indication of how much the outputs produced by the AIML model in the environment of the second network node 502 differ from the reference outputs
An indication of how much the outputs produced by a re-trained or otherwise modified AIML model differ from the reference outputs for the given reference inputs
An indication of whether the execution of the AIML model (i.e., inference) meets the given execution time requirement(s), e.g., the average and/or maximum time for inference is/are below (a) specified threshold(s) for a certain test/verification dataset. If not, an indication of why and/or how much execution time of the AIML model violates the given requirement(s), for example, the execution time was exceeded by 0.1 ms on average and 0.5 ms at maximum due to (e.g., temporarily) limited compute resources
An indication of the performance of the AIML model on (e.g., local) data available at the second network node 502 for one or more of the indicated performance metrics
An indication of whether the performance of the AIML model on (e.g., local) data available at the second network node 502 meets the given requirement(s) with respect to one or more of the indicated performance metrics
A list of samples from the (e.g., local) data available at the second network node 502 which were used to calculate the previously mentioned metrics
An indication of whether the security aspects of the AIML model meet the given security requirements and if not met, which aspects are not satisfactory, and the security aspects/levels supported.

In one embodiment, the [4] conditions or events to be fulfilled for transmitting a report to the first network node 500 comprising information associated to the verification of the AIML model indicated by the first network node 500 may comprise one or more of:
If, for reference inputs, the outputs produced by the AIML model provided by the first network node 500 in the environment of the second network node 502 differ from the associated reference outputs by at least a certain threshold
If, for reference inputs, the outputs produced by a re-trained or otherwise modified AIML model in the environment of the second network node 502 differ from the associated reference outputs by at least a certain threshold
If the execution time of the AIML model (i.e., execution time of AIML model inference) violates the given requirement(s) by at least (a) certain threshold(s)
If the performance of the AIML model on (e.g., local) data available the second network node 502 violates the given requirement(s) with respect to one or more of the indicated performance metrics by at least (a) certain threshold(s)

In one embodiment, the [5] conditions or events to be fulfilled for transmitting the configuration for verifying the AIML model (withholding of the configuration at second network node 502) may comprise one or more of:
If the second network node 502 receives an indication from the third network node, indicating that verification of AIML model is needed/required/desirable
If the second network node 502 determines that verification of AIML model at the third network node is needed/required/recommended
If a certain time interval from the reception of the configuration has passed
If a signaling connection is established or is being established between the third network node and the second network node 502.
If the third network node has indicated to the second network node 502 the support for an AIML model for which the configuration received from the first network node 500 is relevant.

In one embodiment the [6] conditions or events to be fulfilled for determining whether the model is performing as per performance level expected at the first node and to, possibly, send a report confirming successful/unsuccessful verification may comprise one or more of:
If the inputs with the highest weight factor, received in the configuration from the first node, are available at the second network
If the inputs with the highest weight factor, received in the configuration from the first node, are available at the second network with a sufficiently high amount of samples
If any measure needs to be taken by the second node as a remedy to scarce/no availability of inputs with the highest weight factor, such as averaging between sparsely received input samples to derive more input samples, or extrapolating from the input samples received, other input samples.

In the cases above the second network node 502 may send a report to the first network node 500 or to other nodes or systems in the network to highlight the event encountered, for example:
To highlight that all the inputs are available, or that they are available with sufficient samples amount
To highlight that the inputs with highest weight are available, or that they are available with sufficient samples amount
To highlight that the inputs with weight above a threshold are available, or that they are available with sufficient samples amount. Such threshold can be configured at the second node, or at the first node and signaled to the second node.

In one embodiment the [7] and [8] conditions or events to be fulfilled for determining whether the model is performing as per performance level expected at the first node and to, possibly, send a report confirming successful/unsuccessful verification may comprise one or more of:
For one or more inputs required by the model, samples are received at or above the targets received from the first node for frequency and/or frequency ranges and/or cumulative amount of samples in a given time window.
For one or more inputs required by the model, samples are received at or above a value of frequency and/or frequency ranges and/or cumulative amount of samples in a given time window, which ensures a good performance level for the model. Such performance level may be configured at the second node, or at the first node and signaled to the second node.
For one or more outputs produced by the model, results are transmitted to the nodes in need of them at or above the targets received from the first node for frequency and/or frequency ranges and/or cumulative amount of samples in a given time window
For one or more outputs produced by the model, results are transmitted to the nodes in need of them at or above a value of frequency and/or frequency ranges and/or cumulative amount of samples in a given time window, which ensures a good performance level for the model. Such performance level may be configured at the second node, or at the first node and signaled to the second node.

In the cases above the second network node 502 may send a report to the first network node 500 or to other nodes or systems in the network to highlight the event encountered, for example
To highlight that some or all of the inputs required by the model are not received according to the required frequency. Optionally the frequency with which such inputs are received may be included in the report
To highlight that some or all of the outputs produced by the model are not transmitted to the nodes in need of them according to the required frequency. Optionally the frequency with which such outputs are transmitted may be included in the report

In one embodiment the [9] conditions or events to be fulfilled for determining whether the model is performing as per performance level expected at the first node and to, possibly, send a report confirming successful/unsuccessful verification may comprise one or more of:
For one or more inputs required by the model, the semantics of such input information, as communicated by the first node, namely the interpretation of what the input values correspond to, is different from the semantics of the input received by the model inference function via the interfaces connected to the node hosting such function
For one or more outputs produced by the model, the semantics of such output information, as communicated by the first node, namely the interpretation of what the output values correspond to, is different from the semantics of the output transmitted by the node hosting the model inference function via the interfaces connected to it

### Methods Related to a Second Network Node

Some embodiments of the current disclosure include a method executed by a second network node 502 to verify an AIML model provided by a first network node 500 in a radio communication network, the method comprising one or more of the following steps:
Receiving a FIRST MESSAGE from a first network node 500, the FIRST MESSAGE comprising configurations/instructions/semantics information for verifying an AI/ML model.
Transmitting a SECOND MESSAGE to the first network node 500, the SECOND MESSAGE comprising a report associated with verifying an AIML model.

In one embodiment, the second network node 502 may transmit the SECOND MESSAGE to the first network node 500 comprising a report associated with verifying an AIML model based on the configurations/instructions/semantics information received with the FIRST MESSAGE. In this case, the second network node 502 receives a FIRST MESSAGE form the first network prior to transmitting the SECOND MESSAGE to the first network node 500.

In one embodiment, the second network node 502 may transmit the SECOND MESSAGE to the first network node 500 comprising a report associated with verifying an AIML model without prior receiving a FIRST MESSAGE from the first network node 500 comprising configurations/instructions/semantics information for verifying an AI/ML model. In this case, the second network node 502 may without previous configurations/instructions from the first network node 500, run the model verification process and notify the first network node 500 of inconsistencies between the instructions/configurations/semantics relative to the inputs and/or outputs, provided prior to using the AIML model, and the actual availability of the inputs and/or outputs over the connected interfaces to the second network node 502.

The second network node 502 may signal the result of the verification/testing/validation process to any other external node or system in the network, to enable system diagnostic and system optimization

In one embodiment, the second network node 502 may receive, either with the FIRST MESSAGE or with a THIRD MESSAGE, an AIML model from the first network node 500. In this case, the configuration for verifying an AI/ML model provided with the FIRST MESSAGE may be associated to the AIML model provided by the first network node 500 to the second network node 502.

### Embodiments Related to SECOND MESSAGE

In one embodiment, the report associated to verifying an AIML model transmitted by the second network node 502 to the first network node 500 with the SECOND MESSAGE may comprise one or more information elements in the group of
An indication indicating that an AIML model has been verified.
An indication indicating whether the verification of the AIML model was successful or unsuccessful.
The type of verification done for the AIML model. Non limiting examples may include testing, validating, evaluating, etc. An indication or an identity or an identifier of at least a network node that has verified and/or validated the AIML model provided by the first network node 500. The indicated network node could be the second network node 502 itself or a third network node.
One or more information related to at least a condition or event that triggered the verification of the AIML model (either at the second network node 502 or in a third network node).
   A non-limiting example is model re-training. That is, when the AIML model indicated by the FIRST MESSAGE is re-trained by the second network node 502 or by a third network node
One or more information related to how the AIML model has been verified, and details about the result of verification.
   One or more information related to how the AIML model has been tested, and details about the result of the test.
   One or more information related to how the AIML model has been validated, and details about the result of validation. An indication of the type of data used for the AI model verification. In one example, the SECOND MESSAGE may indicate that a set of reference data samples provided by the first network node 500 have been used for verification. In another example, the second network node 502 may indicate that (local) data samples available at the second network node 502 have been used to verify the AIML model. In another example, the second network node 502 may indicate that a combination of reference data samples and local data samples available at the second network node 502 have been used to verify the AIML model.
   An indication of whether the verification of the AIML model and instructions or policies on how to set up, secure, apply, or install the AIML model are exhaustive, comprehensible, and executable. If not, an indication of why the said verification was unsuccessful, for example, a certain software library or version of a certain software library for AI/ML (e.g., TensorFlow) is not available or the execution of Docker container images or other OCI-compliant container images is not possible or otherwise limited
   An indication of whether the verification of the AIML model using the given set of reference data samples associated with the AIML model was successful or unsuccessful. If unsuccessful, an indication of how much the outputs produced by the AIML model in the environment of the second network node 502 differ from the reference outputs
   An indication of how much the outputs produced by a re-trained or otherwise modified AIML model differ from the reference outputs for the given reference inputs.
   An indication of whether the execution of the AIML model (i.e., inference) meets the execution time requirement(s) indicated in the configuration for verifying the AIML model received with in the FIRST MESSAGE. Examples of execution time requirements may comprise, e.g., the average and/or maximum time for inference is/are below (a) specified threshold(s) for a certain test/verification dataset. If not, an indication of why and/or how much execution time of the AIML model violates the given requirement(s), for example, the execution time was exceeded by 0.1 ms on average and 0.5 ms at maximum due to (e.g., temporarily) limited compute resources
   An indication of the performance of the AIML model on (e.g., local) data available the second network node 502 with respect to one or more of the performance metrics indicated in the configuration for verifying the AIML model received with in the FIRST MESSAGE.
   An indication of whether the performance of the AIML model on (e.g., local) data available the second network node 502 meets the given requirement(s) with respect to one or more of the performance metrics indicated in the configuration for verifying the AIML model received with in the FIRST MESSAGE.
   A list of samples from the (e.g., local) data available at the second network node 502 which were used to calculate the previously mentioned metrics
   An indication of whether the security aspects of the AIML model meet the given security requirements and if not met, which aspects are not satisfactory and the minimum security aspects/levels supported.

In one exemplifying case, the second network node 502 may receive an AIML model from the first network node 500 and a configuration to verify the AIML model if/when the second network node 502 or a third network node re-train the AIML model. In one example, the configuration for verifying the AIML mode received with the FIRST MESSAGE may comprise a reference set of data samples for verifying the AIML model. After setting up, applying, installing, or otherwise instantiating the AIML model, the second network node 502 can input the reference inputs to the AIML model and compare the produced outputs to the reference outputs, and thereby test if the AIML model was correctly set up, applied, installed, or instantiated. For instance, the second network node 502 can verify that the AIML model functions as intended if the produced outputs are equal to the reference outputs. Therefore, this has the advantage of allowing the second network node 502 or a third network node to verify whether an AIML model originally trained by another network node, such as the first network node 500, performs as expected under a controlled set of data.

In another example, the reference set of data samples could be used by the second network node 502 (or by a third network node) to test or validate an AIML model provided by the first network node 500 in case the second network node 502 (or a third network node) determines to re-train the AIML model. As such, a network node that re-trains an AIML model provided by the first network node 500 could determine whether the re-trained model performs as expected or within an acceptable range of value.

In one embodiment, the SECOND MESSAGE may comprise an indication that the second network node 502 has successfully or unsuccessfully tested the AIML model in relation to a set of reference data samples associated with the AIML model provided by the first network node 500 to the second network node 502 by means of the FIRST MESSAGE or the THIRD MESSAGE. In this case, the indication of a successful or unsuccessful test of the AIML model provided information related to
One or more performance measure of the successful re-training or modification of the AIML model based on the reference data samples provided by the first network node 500.
One or more performance measure of the unsuccessful re-training or modification of the AIML model based on the reference data samples provided by the first network node 500.

In one embodiment, the SECOND MESSAGE may further comprise one or more of the following information elements
An indication of whether the inputs required by the model are sufficiently available and eventually which of such needed inputs are not available or only available in insufficient amounts
An indication of whether the outputs generated by the model can be delivered with the frequency or according to the amounts specified by the configurations/instructions/semantics information received
An indication of whether the semantics of the inputs received via connected interfaces and/or signaled over connected interfaces are in accordance with the configurations/instructions/semantics information received. In addition, a list of specific inputs/outputs for which the semantics are inconsistent and not matching can be signaled. An indication of whether the resources required by the model to be executed are not available at the second network node 502. In addition, the type of resource not satisfying the model's requirements can be specified

Additional signaling aspects for second network node

In one embodiment, illustrated in FIG. 9, the second network node 502 may additionally
Transmit a FOURTH MESSAGE to a third network node comprising at least part of the configuration for verifying an AIML model received from the first network node 500
Receive a FIFTH MESSAGE from the third network node comprising a report associated to verifying an AIML model based on the configuration received with the FOURTH MESSAGE.

The second network node 502 can therefore act as a relay node between the first network node 500

and the third network node. This could be required, for instance, when a direct interface does not exist between such network nodes. An example of such scenario could be when the first network node 500 is an operation and management (OAM) node, while the second and third network nodes belong to an NG-RAN node with split architecture, such as a gNB-CU-CP and a gNB-DU, respectively.

In one example, the second network node 502 may forward to the third network node the configuration for verifying the AIML model received from the first network node 500. In another example, the second network node 502 may provide to the third network node only a subset of the configuration for verifying the AIML model received from the first network node 500.

FIG. 9 is an illustration of a non-limiting example where the second network node 502 transmits a

FOURTH MESSAGE to a third network node 900 comprising at least part of the configuration for verifying an AIML model received by the first network node 500 and receives a FIFTH MESSAGE from the third network node 900 comprising a report associated to verifying an AIML model

In one embodiment, the second network node 502 may determine the FOURTH MESSAGE based on the FIRST MESSAGE received from the first network node 500. As such, the FOURTH MESSAGE may comprise one or multiple or all the characteristics (e.g., information elements) of the FIRST MESSAGE received by the second network node 502 from the first network node 500 described herein.

In another embodiment, the second network node 502 may determine the SECOND MESSAGE based on the FIFTH MESSAGE received from the third network node 900. Therefore, the FIFTH MESSAGE may comprise one, or multiple or all the characteristics (e.g., information elements) of the SECOND MESSAGE transmitted by the second network node 502 to the first network node 500 described herein.

In another embodiment, prior to receiving the FIRST MESSAGE, the second network node 502 may send a SIXTH MESSAGE to the first network node 500, indicating that verification is needed/required/wanted/preferrable for an AIML model previously received from the first network node 500 (either by the second network node 502 or by a third network node 900), for example due to changes in the environment in which the AIML model operates, capabilities of the second network node 502, capabilities of the third network node 900, automatic or manual configurations applied to the second network node 502 or to the third network node 900 after the AIML model has been provided by the first network node 500.

### Embodiments Related to Network Node Types and Architecture

Regarding possible scenarios of applicability of the methods:
the first network node 500 and/or the second network node 502 can be different RAN nodes (e.g., two gNBs, or two eNBs, or two en-gNBs, or two ng-eNBs)
the first network node 500 and/or the second network node 502 can be different nodes/functions of a same RAN node (e.g., a gNB-CU-CP and a gNB-DU, or a gNB-CU-CP and a gNB-CU-UP)
the first network node 500 can be a RAN node (e.g., one gNB, or one eNB, or one en-gNB, or one ng-eNB) and the second network node 502 can be a component/node/function of a second RAN node (e.g., gNB-CU-CP)
the first network node 500 and/or the second network node 502 can pertain to the same Radio Access Technology (e.g., e.g., E-UTRAN, LTE, NG-RAN, ORAN, WiFi, etc.) or to different Radio Access Technologies (e.g., one to NR and the other to E-UTRAN or WiFi)
the first network node 500 and/or the second network node 502 can pertain to the same RAN system (e.g., E-UTRAN, LTE, NG-RAN, ORAN, WiFi, etc.) or to different RAN systems (e.g., one to NG-RAN and the other to E-UTRAN)
the first network node 500 and the second network node 502 may be connected via a direct signaling connection (e.g., two gNB via XnAP), or an indirect signaling connection (e.g., an e-NB and a gNB via S1AP, NGAP and one or more Core Network nodes, e.g., an MME and an AMF)
the first network node 500 can be a management system, such as the OAM system or the SMO, while the second network node 502 can consist of a RAN node or function.
The first network node 500 can be a RAN node or function while the second network node 502 can be a management system, such as the OAM or the SMO.
the first network node 500 can be a core network node or function, such a 5GC function, while the second network node 502 can consist of a RAN node or function.
The first network node 500 can be a RAN node or function while the second network node 502 can be a core network node or function, such a 5GC function.
the first network node 500 and/or the second network node 502 and/or the third network node 900 can be different nodes/functions of a same RAN node (e.g., a gNB-CU-CP and a gNB-DU, or a gNB-CU-CP and a gNB-CU-UP)

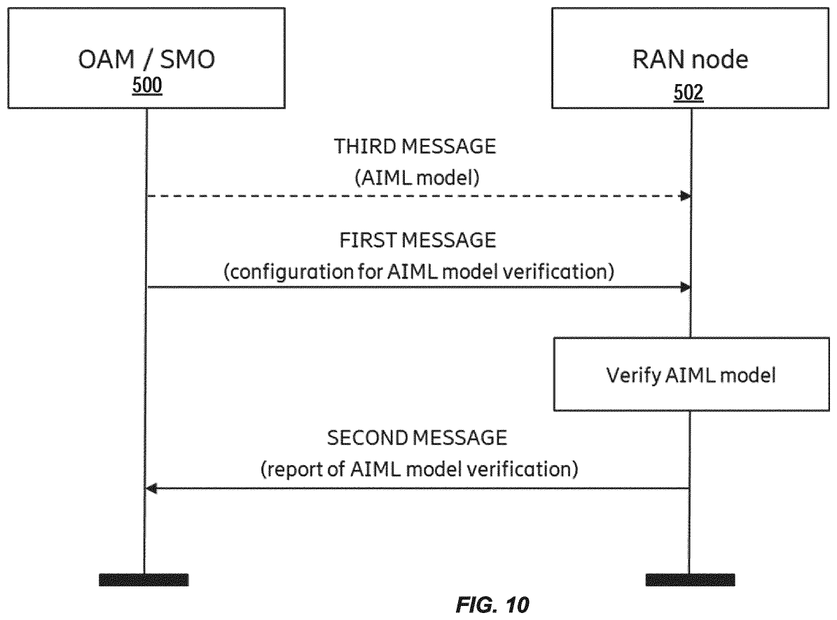

In one non-limiting example illustrated in FIG. 10, the first network node 500 can be an Operation And Maintenance (OAM) or a Service and Management Orchestration (SMO) node, while the second network node 502 could be a RAN node. Non limiting examples of RAN nodes may include, an E-UTRAN node (such as a eNB, en-ENB, etc.), a NG-RAN node (such as gNB, gNB-CU-CP, gNB-DU, etc.), a WiFi access point, etc.

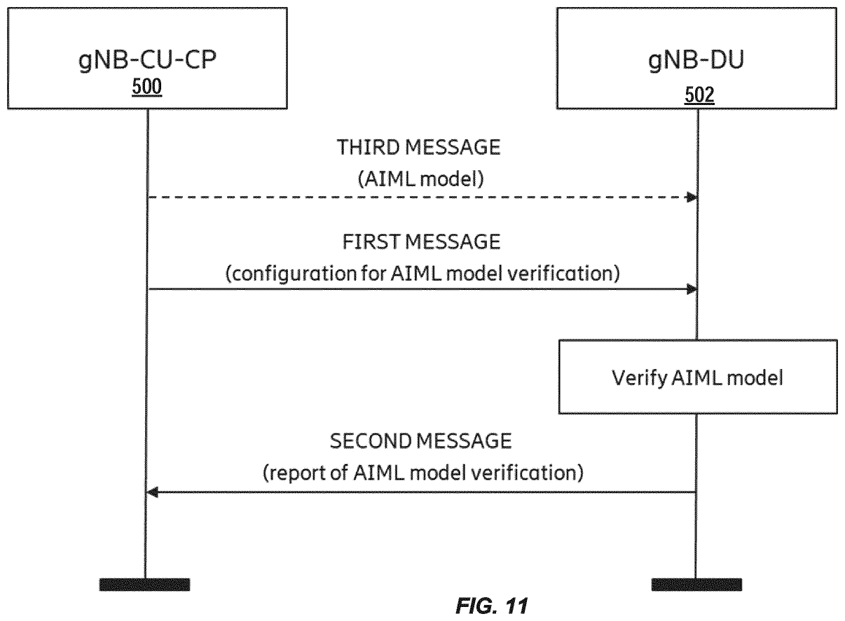

FIG. 11 illustrates a non-limiting example of the method wherein the first network node 500 is a gNB-CU-CP and the second network node 502 is a gNB-DU. In this example, the messages disclosed by the method would be transmitted over the F1AP interface of an NG-RAN system. However, different combinations of E-UTRAN and NG-RAN nodes may lead to different implementation of the embodiments disclosed where the messages herein disclosed to be transmitted/received between a first network node 500 and second network node 502 would be conveyed over different interfaces of the E-UTRAN and NG-RAN systems. Non limiting examples of such interfaces are S1AP, X2AP, NGAP, XnAP, F1AP, E1AP, etc.

Similarly, in alternative implementations where the first and second network node 502 represent nodes of an O-RAN system, the messages herein disclosed to be transmitted/received between a first network node 500 and second network node 502 would be conveyed over different interfaces of the O-RAN system. In the same way, the method could be applied to network nodes of other radio access technologies (RATs), or network communication platforms such as ONAP, WiFi, etc., in which case the specific communication interface of such RATs would be used to signal the messages herein disclosed between two network nodes.

FIG. 11 shows an illustration of a non-limiting example of the method wherein the first network node 500 is a gNB-CU-CP and the second network node 502 is a gNB-DU. In this example, the messages disclosed by the method would be transmitted over the F1 interface of an NG-RAN system.

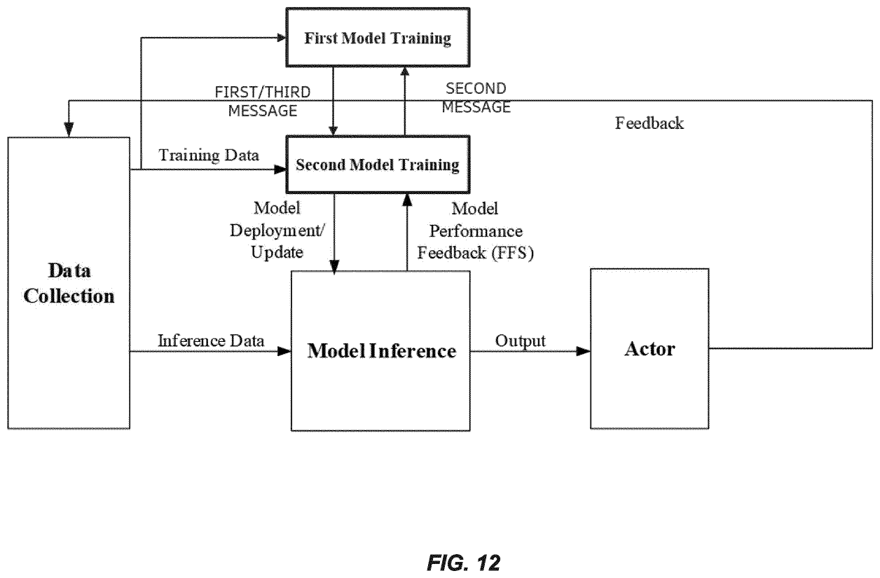

In one possible implementation of the method, the first network node 500 is a logical node hosting a first training function, while the second network node 502 is a second logical node hosting a second training function. FIG. 12 shows a non-limiting example of how the method can be mapped to the AIML functional framework for the NG-RAN and E-UTRAN system defined by 3GPP. In this case, two logical nodes hosting two model training functions interact by exchanging messages as discussed herein. In another example, the second network node 502 could be provided with a reference set of data samples by the first network node 500 to test or validate an AIML model provided by the first network node 500 in case the second network node 502 re-trains or modifies the AIML model. As such, a network node that re-trains an AIML model provided by the first network node 500 could determine whether the re-trained model performs as expected or within acceptable ranges of values. The second network node 502 could use the reference dataset to verify the AIML model prior to using it or upon re-training it.

FIG. 12 shows a non-limiting example of how the method can be mapped to the AIML functional framework for the NG-RAN and E-UTRAN system defined by 3GPP.

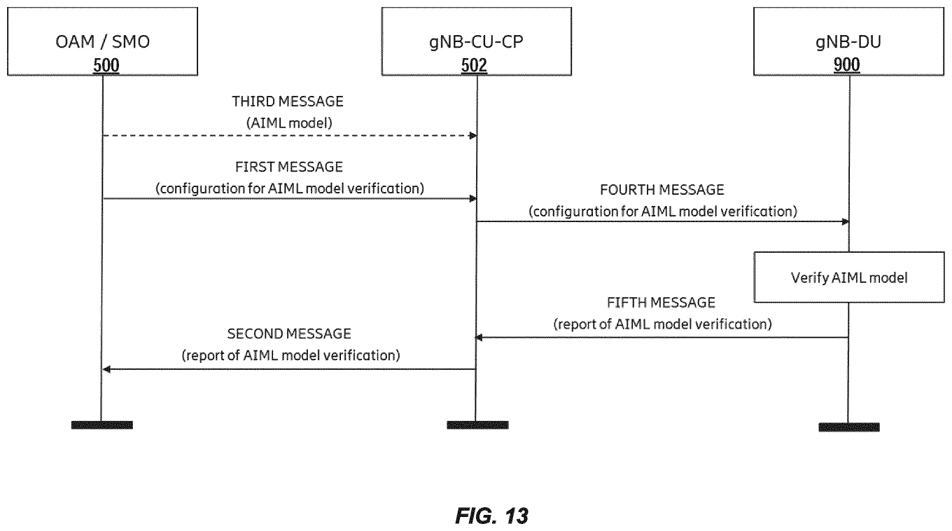

FIG. 13 shows a non-limiting example of such scenario where the first network node 500 is an OAM node, while the second and third network node 900s belong to an NG-RAN node with split architecture, such as a gNB-CU-CP and a gNB-DU, respectively. In one exemplifying case, the first network node 500 (OAM) and the second network node 502 (gNB-CU-CP) may host a first and a second training function, while the third network node 900 could host an inference function. In other examples, also the third network node 900 may be the host of a training function. An AIML model generated/trained by an OAM/SMO node could be provided to a gNB-DU via a gNB-CU-CP, and the gNB-DU may be required to verify the AIML model prior to using it for inference.

### Extension of the Method to a List of AIML Models

The embodiments previously indicated can apply to a list of AIML models, meaning that at least one of the messages (FIRST MESSAGE, SECOND MESSAGE, THIRD MESSAGE, FOURTH MESSAGE, FIFTH MESSAGE, SIXTH MESSAGE) and/or at least one of the embodiments previously stated can pertain to a list of configurations/reports instead of a single configuration/report.

For example, one FIRST MESSAGE can comprise a list of configurations for verifying a list of AI/ML models. In a possible realization of the method, the first network node 500 (e.g., an OAM or an SMO or a CN node) can send to a second network node 502 (e.g., a RAN node) a list of configurations for verifying a list of AIML models to be verified by one or more third network node 900s, wherein requests to verify different AIML models are forwarded from the second network node 502 to a third network node 900 based on configuration parameters, characteristics, or capabilities of the third network node 900. In another example, the second network node 502 is a gNB-CU-CP, the third network node 900s are gNB-DUs with different hardware capabilities, and verification of different AIML models should be executed by the different gNB-DUs.

In another possible example of realization of the FIRST MESSAGE, the first network node 500 (e.g., an OAM or an SMO or a CN node) can send to a second network node 502 (e.g., a gNB-CU-CP) a list of configurations for verifying a list of AIML models and the verification should be carried out by the second network node 502. For example, an AIML model 1 is applicable to services with stringent requirements on delay, an AIML model 2 is applicable to services with stringent requirements on packet loss.

Similarly:
one SECOND MESSAGE can be used to report the verification of a list of AIML models.
one THIRD MESSAGE can comprise more than one AIML model sent from the first network node 500 to the second network node 502.
one FOURTH MESSAGE transmitted by the second network node 502 can comprise more than one configurations
one FIFTH MESSAGE can comprise reports associated to verifying more than one AIML model.
one SIXTH MESSAGE can be used to indicate the need for a verification of a list of previously deployed AIML models.

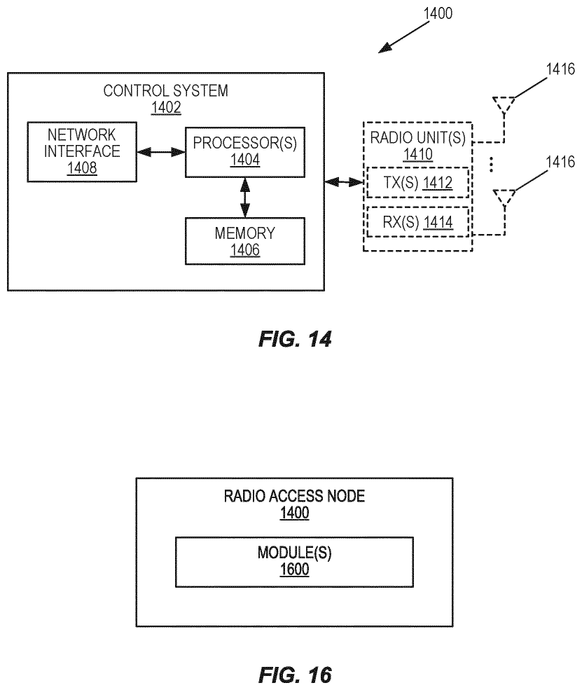

FIG. 14 is a schematic block diagram of a radio access node 1400 according to some embodiments of the present disclosure. Optional features are represented by dashed boxes. The radio access node 1400 may be, for example, a base station 202 or 206 or a network node that implements all or part of the functionality of the base station 202 or gNB described herein. As illustrated, the radio access node 1400 includes a control system 1402 that includes one or more processors 1404 (e.g., Central Processing Units (CPUs), Application Specific Integrated Circuits (ASICs), Field Programmable Gate Arrays (FPGAs), and/or the like), memory 1406, and a network interface 1408. The one or more processors 1404 are also referred to herein as processing circuitry. In addition, the radio access node 1400 may include one or more radio units 1410 that each includes one or more transmitters 1412 and one or more receivers 1414 coupled to one or more antennas 1416. The radio units 1410 may be referred to or be part of radio interface circuitry. In some embodiments, the radio unit(s) 1410 is external to the control system 1402 and connected to the control system 1402 via, e.g., a wired connection (e.g., an optical cable). However, in some other embodiments, the radio unit(s) 1410 and potentially the antenna(s) 1416 are integrated together with the control system 1402. The one or more processors 1404 operate to provide one or more functions of a radio access node 1400 as described herein. In some embodiments, the function(s) are implemented in software that is stored, e.g., in the memory 1406 and executed by the one or more processors 1404.

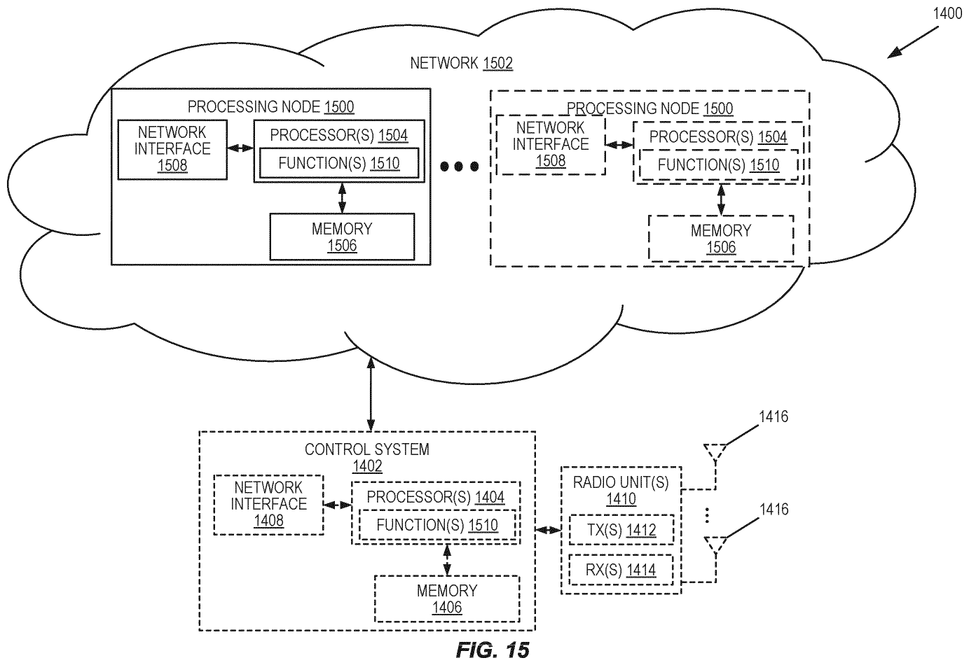

FIG. 15 is a schematic block diagram that illustrates a virtualized embodiment of the radio access node 1400 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 1400 in which at least a portion of the functionality of the radio access node 1400 is implemented as a virtual component(s) (e.g., via a virtual machine(s) executing on a physical processing node(s) in a network(s)). As illustrated, in this example, the radio access node 1400 may include the control system 1402 and/or the one or more radio units 1410, as described above. The control system 1402 may be connected to the radio unit(s) 1410 via, for example, an optical cable or the like. The radio access node 1400 includes one or more processing nodes 1500 coupled to or included as part of a network(s) 1502. If present, the control system 1402 or the radio unit(s) are connected to the processing node(s) 1500 via the network 1502. Each processing node 1500 includes one or more processors 1504 (e.g., CPUs, ASICs, FPGAs, and/or the like), memory 1506, and a network interface 1508.

In this example, functions 1510 of the radio access node 1400 described herein are implemented at the one or more processing nodes 1500 or distributed across the one or more processing nodes 1500 and the control system 1402 and/or the radio unit(s) 1410 in any desired manner. In some particular embodiments, some or all of the functions 1510 of the radio access node 1400 described herein are implemented as virtual components executed by one or more virtual machines implemented in a virtual environment(s) hosted by the processing node(s) 1500. As will be appreciated by one of ordinary skill in the art, additional signaling or communication between the processing node(s) 1500 and the control system 1402 is used in order to carry out at least some of the desired functions 1510. Notably, in some embodiments, the control system 1402 may not be included, in which case the radio unit(s) 1410 communicate directly with the processing node(s) 1500 via an appropriate network interface(s).

In some embodiments, a computer program including instructions which, when executed by at least one processor, causes the at least one processor to carry out the functionality of radio access node 1400 or a node (e.g., a processing node 1500) implementing one or more of the functions 1510 of the radio access node 1400 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 16 is a schematic block diagram of the radio access node 1400 according to some other embodiments of the present disclosure. The radio access node 1400 includes one or more modules 1600, each of which is implemented in software. The module(s) 1600 provide the functionality of the radio access node 1400 described herein. This discussion is equally applicable to the processing node 1500 of FIG. 15 where the modules 1600 may be implemented at one of the processing nodes 1500 or distributed across multiple processing nodes 1500 and/or distributed across the processing node(s) 1500 and the control system 1402.

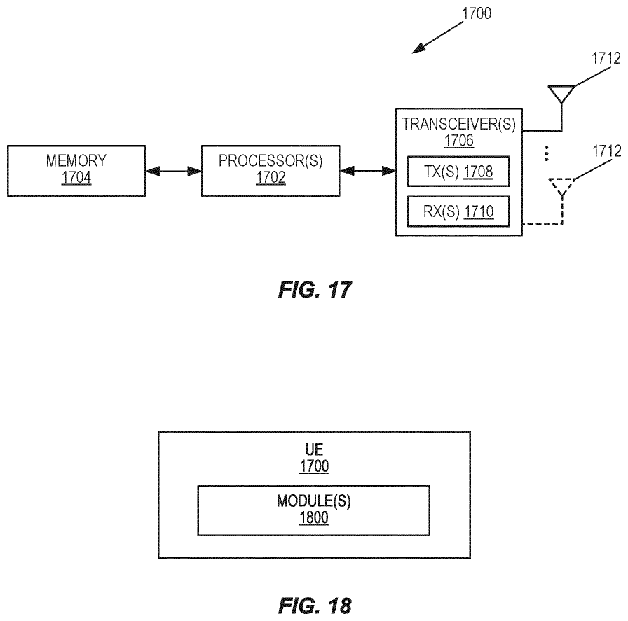

FIG. 17 is a schematic block diagram of a wireless communication device 1700 according to some embodiments of the present disclosure. As illustrated, the wireless communication device 1700 includes one or more processors 1702 (e.g., CPUs, ASICs, FPGAs, and/or the like), memory 1704, and one or more transceivers 1706 each including one or more transmitters 1708 and one or more receivers 1710 coupled to one or more antennas 1712. The transceiver(s) 1706 includes radio-front end circuitry connected to the antenna(s) 1712 that is configured to condition signals communicated between the antenna(s) 1712 and the processor(s) 1702, as will be appreciated by on of ordinary skill in the art. The processors 1702 are also referred to herein as processing circuitry. The transceivers 1706 are also referred to herein as radio circuitry. In some embodiments, the functionality of the wireless communication device 1700 described above may be fully or partially implemented in software that is, e.g., stored in the memory 1704 and executed by the processor(s) 1702. Note that the wireless communication device 1700 may include additional components not illustrated in FIG. 17 such as, e.g., one or more user interface components (e.g., an input/output interface including a display, buttons, a touch screen, a microphone, a speaker(s), and/or the like and/or any other components for allowing input of information into the wireless communication device 1700 and/or allowing output of information from the wireless communication device 1700), a power supply (e.g., a battery and associated power circuitry), etc.

In some embodiments, a computer program including instructions which, when executed by at least one processor, causes the at least one processor to carry out the functionality of the wireless communication device 1700 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 18 is a schematic block diagram of the wireless communication device 1700 according to some other embodiments of the present disclosure. The wireless communication device 1700 includes one or more modules 1800, each of which is implemented in software. The module(s) 1800 provide the functionality of the wireless communication device 1700 described herein.

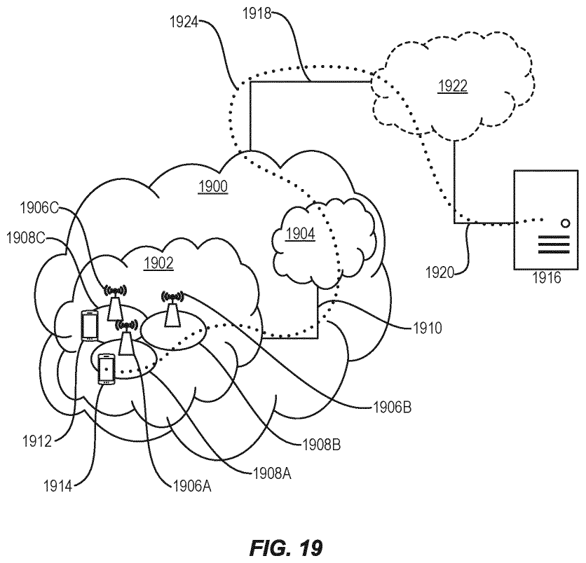

With reference to FIG. 19, in accordance with an embodiment, a communication system includes a telecommunication network 1900, such as a 3GPP-type cellular network, which comprises an access network 1902, such as a RAN, and a core network 1904. The access network 1902 comprises a plurality of base stations 1906A, 1906B, 1906C, such as Node Bs, eNBs, gNBs, or other types of wireless Access Points (APs), each defining a corresponding coverage area 1908A, 1908B, 1908C. Each base station 1906A, 1906B, 1906C is connectable to the core network 1904 over a wired or wireless connection 1910. A first UE 1912 located in coverage area 1908C is configured to wirelessly connect to, or be paged by, the corresponding base station 1906C. A second UE 1914 in coverage area 1908A is wirelessly connectable to the corresponding base station 1906A. While a plurality of UEs 1912, 1914 are illustrated in this example, the disclosed embodiments are equally applicable to a situation where a sole UE is in the coverage area or where a sole UE is connecting to the corresponding base station 1906.

The telecommunication network 1900 is itself connected to a host computer 1916, which may be embodied in the hardware and/or software of a standalone server, a cloud-implemented server, a distributed server, or as processing resources in a server farm. The host computer 1916 may be under the ownership or control of a service provider, or may be operated by the service provider or on behalf of the service provider. Connections 1918 and 1920 between the telecommunication network 1900 and the host computer 1916 may extend directly from the core network 1904 to the host computer 1916 or may go via an optional intermediate network 1922. The intermediate network 1922 may be one of, or a combination of more than one of, a public, private, or hosted network; the intermediate network 1922, if any, may be a backbone network or the Internet; in particular, the intermediate network 1922 may comprise two or more sub-networks (not shown).

The communication system of FIG. 19 as a whole enables connectivity between the connected UEs 1912, 1914 and the host computer 1916. The connectivity may be described as an Over-the-Top (OTT) connection 1924. The host computer 1916 and the connected UEs 1912, 1914 are configured to communicate data and/or signaling via the OTT connection 1924, using the access network 1902, the core network 1904, any intermediate network 1922, and possible further infrastructure (not shown) as intermediaries. The OTT connection 1924 may be transparent in the sense that the participating communication devices through which the OTT connection 1924 passes are unaware of routing of uplink and downlink communications. For example, the base station 1906 may not or need not be informed about the past routing of an incoming downlink communication with data originating from the host computer 1916 to be forwarded (e.g., handed over) to a connected UE 1912. Similarly, the base station 1906 need not be aware of the future routing of an outgoing uplink communication originating from the UE 1912 towards the host computer 1916.

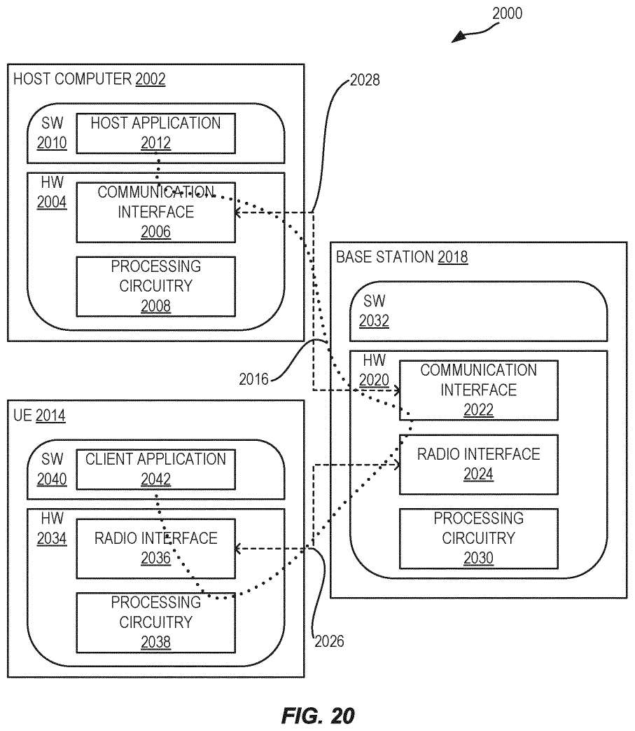

Example implementations, in accordance with an embodiment, of the UE, base station, and host computer discussed in the preceding paragraphs will now be described with reference to FIG. 20. In a communication system 2000, a host computer 2002 comprises hardware 2004 including a communication interface 2006 configured to set up and maintain a wired or wireless connection with an interface of a different communication device of the communication system 2000. The host computer 2002 further comprises processing circuitry 2008, which may have storage and/or processing capabilities. In particular, the processing circuitry 2008 may comprise one or more programmable processors, ASICs, FPGAs, or combinations of these (not shown) adapted to execute instructions. The host computer 2002 further comprises software 2010, which is stored in or accessible by the host computer 2002 and executable by the processing circuitry 2008. The software 2010 includes a host application 2012. The host application 2012 may be operable to provide a service to a remote user, such as a UE 2014 connecting via an OTT connection 2016 terminating at the UE 2014 and the host computer 2002. In providing the service to the remote user, the host application 2012 may provide user data which is transmitted using the OTT connection 2016.

The communication system 2000 further includes a base station 2018 provided in a telecommunication system and comprising hardware 2020 enabling it to communicate with the host computer 2002 and with the UE 2014. The hardware 2020 may include a communication interface 2022 for setting up and maintaining a wired or wireless connection with an interface of a different communication device of the communication system 2000, as well as a radio interface 2024 for setting up and maintaining at least a wireless connection 2026 with the UE 2014 located in a coverage area (not shown in FIG. 20) served by the base station 2018. The communication interface 2022 may be configured to facilitate a connection 2028 to the host computer 2002. The connection 2028 may be direct or it may pass through a core network (not shown in FIG. 20) of the telecommunication system and/or through one or more intermediate networks outside the telecommunication system. In the embodiment shown, the hardware 2020 of the base station 2018 further includes processing circuitry 2030, which may comprise one or more programmable processors, ASICs, FPGAs, or combinations of these (not shown) adapted to execute instructions. The base station 2018 further has software 2032 stored internally or accessible via an external connection.

The communication system 2000 further includes the UE 2014 already referred to. The UE's 2014 hardware 2034 may include a radio interface 2036 configured to set up and maintain a wireless connection 2026 with a base station serving a coverage area in which the UE 2014 is currently located. The hardware 2034 of the UE 2014 further includes processing circuitry 2038, which may comprise one or more programmable processors, ASICs, FPGAs, or combinations of these (not shown) adapted to execute instructions. The UE 2014 further comprises software 2040, which is stored in or accessible by the UE 2014 and executable by the processing circuitry 2038. The software 2040 includes a client application 2042. The client application 2042 may be operable to provide a service to a human or non-human user via the UE 2014, with the support of the host computer 2002. In the host computer 2002, the executing host application 2012 may communicate with the executing client application 2042 via the OTT connection 2016 terminating at the UE 2014 and the host computer 2002. In providing the service to the user, the client application 2042 may receive request data from the host application 2012 and provide user data in response to the request data. The OTT connection 2016 may transfer both the request data and the user data. The client application 2042 may interact with the user to generate the user data that it provides.

It is noted that the host computer 2002, the base station 2018, and the UE 2014 illustrated in FIG. 20 may be similar or identical to the host computer 1916, one of the base stations 1906A, 1906B, 1906C, and one of the UEs 1912, 1914 of FIG. 19, respectively. This is to say, the inner workings of these entities may be as shown in FIG. 20 and independently, the surrounding network topology may be that of FIG. 19.

In FIG. 20, the OTT connection 2016 has been drawn abstractly to illustrate the communication between the host computer 2002 and the UE 2014 via the base station 2018 without explicit reference to any intermediary devices and the precise routing of messages via these devices. The network infrastructure may determine the routing, which may be configured to hide from the UE 2014 or from the service provider operating the host computer 2002, or both. While the OTT connection 2016 is active, the network infrastructure may further take decisions by which it dynamically changes the routing (e.g., on the basis of load balancing consideration or reconfiguration of the network).

The wireless connection 2026 between the UE 2014 and the base station 2018 is in accordance with the teachings of the embodiments described throughout this disclosure. One or more of the various embodiments improve the performance of OTT services provided to the UE 2014 using the OTT connection 2016, in which the wireless connection 2026 forms the last segment. More precisely, the teachings of these embodiments may improve the e.g., data rate, latency, power consumption, etc. and thereby provide benefits such as e.g., reduced user waiting time, relaxed restriction on file size, better responsiveness, extended battery lifetime, etc.

A measurement procedure may be provided for the purpose of monitoring data rate, latency, and other factors on which the one or more embodiments improve. There may further be an optional network functionality for reconfiguring the OTT connection 2016 between the host computer 2002 and the UE 2014, in response to variations in the measurement results. The measurement procedure and/or the network functionality for reconfiguring the OTT connection 2016 may be implemented in the software 2010 and the hardware 2004 of the host computer 2002 or in the software 2040 and the hardware 2034 of the UE 2014, or both. In some embodiments, sensors (not shown) may be deployed in or in association with communication devices through which the OTT connection 2016 passes; the sensors may participate in the measurement procedure by supplying values of the monitored quantities exemplified above, or supplying values of other physical quantities from which the software 2010, 2040 may compute or estimate the monitored quantities. The reconfiguring of the OTT connection 2016 may include message format, retransmission settings, preferred routing, etc.; the reconfiguring need not affect the base station 2018, and it may be unknown or imperceptible to the base station 2018. Such procedures and functionalities may be known and practiced in the art. In certain embodiments, measurements may involve proprietary UE signaling facilitating the host computer 2002′s measurements of throughput, propagation times, latency, and the like. The measurements may be implemented in that the software 2010 and 2040 causes messages to be transmitted, in particular empty or ‘dummy’ messages, using the OTT connection 2016 while it monitors propagation times, errors, etc.

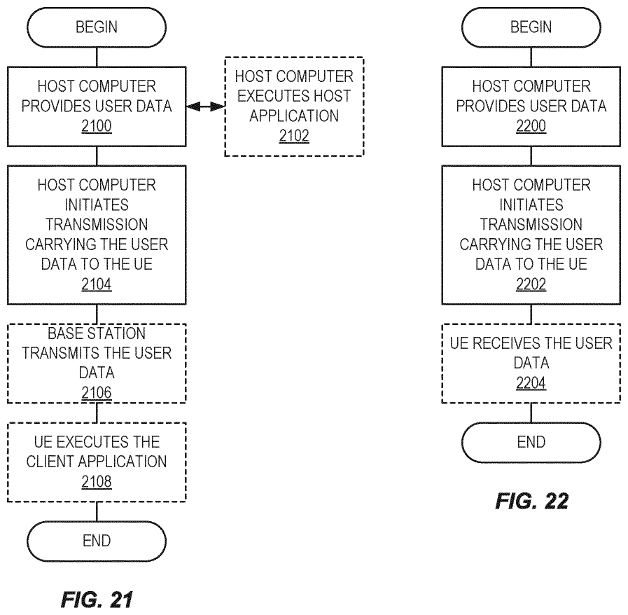

FIG. 21 is a flowchart illustrating a method implemented in a communication system, in accordance with one embodiment. The communication system includes a host computer, a base station, and a UE which may be those described with reference to FIGS. 19 and 20. For simplicity of the present disclosure, only drawing references to FIG. 21 will be included in this section. In step 2100, the host computer provides user data. In sub-step 2102 (which may be optional) of step 2100, the host computer provides the user data by executing a host application. In step 2104, the host computer initiates a transmission carrying the user data to the UE. In step 2106 (which may be optional), the base station transmits to the UE the user data which was carried in the transmission that the host computer initiated, in accordance with the teachings of the embodiments described throughout this disclosure. In step 2108 (which may also be optional), the UE executes a client application associated with the host application executed by the host computer.

FIG. 22 is a flowchart illustrating a method implemented in a communication system, in accordance with one embodiment. The communication system includes a host computer, a base station, and a UE which may be those described with reference to FIGS. 19 and 20. For simplicity of the present disclosure, only drawing references to FIG. 22 will be included in this section. In step 2200 of the method, the host computer provides user data. In an optional sub-step (not shown) the host computer provides the user data by executing a host application. In step 2202, the host computer initiates a transmission carrying the user data to the UE. The transmission may pass via the base station, in accordance with the teachings of the embodiments described throughout this disclosure. In step 2204 (which may be optional), the UE receives the user data carried in the transmission.

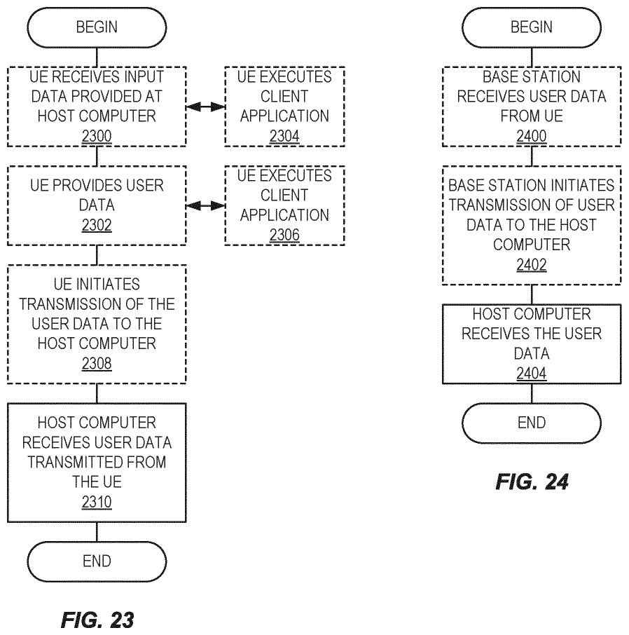

FIG. 23 is a flowchart illustrating a method implemented in a communication system, in accordance with one embodiment. The communication system includes a host computer, a base station, and a UE which may be those described with reference to FIGS. 19 and 20. For simplicity of the present disclosure, only drawing references to FIG. 23 will be included in this section. In step 2300 (which may be optional), the UE receives input data provided by the host computer. Additionally, or alternatively, in step 2302, the UE provides user data. In sub-step 2304 (which may be optional) of step 2300, the UE provides the user data by executing a client application. In sub-step 2306 (which may be optional) of step 2302, the UE executes a client application which provides the user data in reaction to the received input data provided by the host computer. In providing the user data, the executed client application may further consider user input received from the user. Regardless of the specific manner in which the user data was provided, the UE initiates, in sub-step 2308 (which may be optional), transmission of the user data to the host computer. In step 2310 of the method, the host computer receives the user data transmitted from the UE, in accordance with the teachings of the embodiments described throughout this disclosure.

FIG. 24 is a flowchart illustrating a method implemented in a communication system, in accordance with one embodiment. The communication system includes a host computer, a base station, and a UE which may be those described with reference to FIGS. 19 and 20. For simplicity of the present disclosure, only drawing references to FIG. 24 will be included in this section. In step 2400 (which may be optional), in accordance with the teachings of the embodiments described throughout this disclosure, the base station receives user data from the UE. In step 2402 (which may be optional), the base station initiates transmission of the received user data to the host computer. In step 2404 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

### Embodiments

### Group A Embodiments

Embodiment 1: A method performed by a first network node (500), the method comprising one or more of: transmitting a FIRST MESSAGE towards a second network node (502), the FIRST MESSAGE comprising verification information for verifying a model; and receiving a SECOND MESSAGE transmitted by the second network node (502), the SECOND MESSAGE comprising a report associated with verifying a model.

Embodiment 2: The method of embodiment 1 wherein the model is an Artificial Intelligence, AI, and/or Machine Learning, ML, model.

Embodiment 3: The method of any of embodiments 1-2 wherein the verification information for verifying the model comprises: configurations/instructions/semantics information for verifying the model.

Embodiment 4: The method of any of embodiments 1-3 wherein the verification information provided to the second network node (502) is intended for verifying that the model can perform as per the tested and validated performance at the first network node (500) or at least as per an acceptable performance level.

Embodiment 5: The method of any of embodiments 1-4 wherein receiving the SECOND MESSAGE from the second network node (502) comprises receiving a report associated with verifying the model based on the verification information received with the FIRST MESSAGE.

Embodiment 6: The method of any of embodiments 1-5 wherein the first network node (500) receives the SECOND MESSAGE from the second network node (502) upon transmitting the FIRST MESSAGE to the second network node (502).

Embodiment 7: The method of any of embodiments 1-5 wherein receiving the SECOND MESSAGE from the second network node (502) comprises receiving a report associated with verifying the model without prior transmitting of the FIRST MESSAGE to the second network node (502).

Embodiment 8: The method of any of embodiments 1-7 further comprising: providing, either with the FIRST MESSAGE or with a THIRD MESSAGE, a model to the second network node (502) and the verification information for verifying a model associated to the model provided by the first network node 500.

Embodiment 9: The method of any of embodiments 1-8 further comprising: providing to the second network node (502), either with the FIRST MESSAGE or with a THIRD MESSAGE, a set of reference data samples which can be used to verify the model.

Embodiment 10: The method of embodiment 9 wherein the set of reference data samples is provided with the FIRST MESSAGE as part of the configuration for verifying the model.

Embodiment 11: The method of any of embodiments 1-10 wherein the provided reference data samples are explicitly associated to one or more models.

Embodiment 12: The method of any of embodiments 9-11 wherein the provided reference data samples comprise one or more of: a. a set of reference input-output pairs, where each reference output value represents that output that is expected to obtain for the corresponding reference input data when provided to the model for verification; and b. reference state-action pairs, wherein the reference action represents either the expected output of the model or the decision of an AIML algorithm using the model, when feeding the model with the reference state.

Embodiment 13: The method of any of embodiments 1-12 wherein the configuration for verifying the model may comprise one or more information elements in the group of: a. an identity or an identifier of a model to which the configuration for verification is applicable to or associated to; b. an indication to verify a model; c. an instruction to verify a model; and d. a recommendation to verify a model.

Embodiment 14: The method of any of embodiments 1-13 wherein the verification information provided with the FIRST MESSAGE may further include an indication of at least one network node to which the provided configuration is associated to.

Embodiment 15: The method of embodiment 14 wherein the at least one network node to which the provided configuration is associated to is the second network node (502) or a third network node (900).

Embodiment 16: The method of any of embodiments 1-15 wherein the verification information for verifying the model comprises one or more information related to verifying the model in the group of: a. One or more conditions or events to be fulfilled for triggering the verification of the model indicated by the first network node 500; b. One or more instructions or policies or recommendations related to verification of the model indicated by the first network node 500; c. A request to transmit to the first network node 500 a report comprising information associated to the verification of the model indicated by the first network node 500; d. One or more conditions or events to be fulfilled for transmitting a report to the first network node 500 comprising information associated to the verification of the model indicated by the first network node (500); e. One or more conditions or events to be fulfilled for transmitting/forwarding (to a third network node (900) the configuration for verifying the model (withholding of the configuration at second network node (502); f. Weight factors for each input needed by the model, namely revealing the importance/priority of each input type with respect to the process of inference carried out by the model; g. Frequency and/or frequency ranges and/or cumulative amount of samples in a given time window, with which each type of input is assumed to be received in order to allow the model to perform according to its tested performance or according to a sufficiently good performance level established by the first node; h. Frequency and/or frequency ranges and/or cumulative number of samples in a given time window, with which each type of output is assumed to be generated in order to allow the model to perform according to its tested performance or according to a sufficiently good performance level established by the first node; and i.

Semantics of the inputs needed at the model and/or of the outputs generated by the model.

Embodiment 17: The method of any of embodiments 1-16 wherein the first network node (500) comprises one or more of: an Operation and management (OAM) node; and a service and management orchestration (SMO) node, while the second network node (502) comprises one or more of: a RAN node (such as NG-RAN node); a function of a RAN node (gNB, gNB-CU-CP, . . . ); a network node realizing at least in part a Non-Real Time Radio Intelligent Controller (Non-Real Time RIC); a network node realizing at least in part a Near-Real Time RIC; a Core Network node; and a Cloud-based centralized training node.

Embodiment 18: The method of any of embodiments 1-17, further comprising: providing user data; and forwarding the user data to a host computer via the transmission to the base station.

### Group B Embodiments

Embodiment 19: A method performed by a second network node (502), the method comprising one or more of: receiving a FIRST MESSAGE transmitted by a first network node (500), the FIRST MESSAGE comprising verification information for verifying a model; and transmitting a SECOND MESSAGE towards the first network node (500), the SECOND MESSAGE comprising a report associated with verifying a model.

Embodiment 20: The method of embodiment 19 wherein the model is an Artificial Intelligence, AI, and/or Machine Learning, ML, model.

Embodiment 21: The method of any of embodiments 19-20 wherein the verification information for verifying the model comprises: configurations/instructions/semantics information for verifying the model.

Embodiment 22: The method of any of embodiments 19-21 wherein the report associated with verifying the model is based on the verification information received with the FIRST MESSAGE.

Embodiment 23: The method of any of embodiments 19-21 wherein the SECOND MESSAGE is transmitted towards the first network node (500) without prior receiving the FIRST MESSAGE from the first network node (500).

Embodiment 24: The method of embodiments 23 wherein the second network node (502), without previous configurations/instructions from the first network node (500), runs the model verification process and notifies the first network node (500) of inconsistencies between the instructions/configurations/semantics relative to the inputs and/or outputs, provided prior to using the model, and the actual availability of the inputs and/or outputs over the connected interfaces to the second network node (502).

Embodiment 25: The method of any of embodiments 19-24 further comprising signaling the result of the verification/testing/validation process to any other external node or system in the network, to enable system diagnostic and system optimization.

Embodiment 26: The method of any of embodiments 19-25 further comprising: receiving, either with the FIRST MESSAGE or with a THIRD MESSAGE, a model from the first network node (500).

Embodiment 27: The method of embodiment 26 wherein the configuration for verifying a model provided with the FIRST MESSAGE is associated to the model provided by the first network node (500) to the second network node (502).

Embodiment 28: The method of any of embodiments 19-20 further comprising one or more of: transmitting a FOURTH MESSAGE towards a third network node (900), the FOURTH MESSAGE comprising at least part of the configurations/instructions/semantics information for verifying a model received from the first network node (500); and receiving a FIFTH MESSAGE transmitted by the third network node (900), the FIFTH MESSAGE comprising a report associated to verifying a model based on the configurations/instructions/semantics information received with the FOURTH MESSAGE.

Embodiment 29: The method of embodiment 28 further comprising: forwarding the report received from the third network node (900) to the first network node (500) via the SECOND MESSAGE.

Embodiment 30: The method of any of embodiments 19-29 wherein the report associated to verifying the model transmitted by the second network node (502) to the first network node (500) with the SECOND MESSAGE comprises one or more information elements in the group of: a. an indication indicating that the model has been verified; b. an indication indicating whether the verification of the model was successful or unsuccessful; c. the type of verification done for the model. Non limiting examples may include testing, validating, evaluating, etc.; d. an indication or an identity or an identifier of at least a network node that has verified and/or validated the model provided by the first network node (500). The indicated network node could be the second network node (502) itself or a third network node (900); e. one or more information related to at least a condition or event that triggered the verification of the model; i. a non-limiting example is model re-training, e.g., when the model indicated by the FIRST MESSAGE is re-trained by the second network node (502) or by a third network node (900); f. one or more information related to how the model has been verified, and details about the result of verification; g. one or more information related to how the model has been tested, and details about one or more information related to how the model has been validated, and details the result of the test; h.

about the result of validation; i. an indication of whether the inputs required by the model are sufficiently available and eventually which of such needed inputs are not available or only available in insufficient amounts; j. an indication of whether the outputs generated by the model can be delivered with the frequency or according to the amounts specified by the configurations/instructions/semantics information received; k. an indication of whether the semantics of the inputs received via connected interfaces and/or signaled over connected interfaces are in accordance with the configurations/instructions/semantics information received; and I. an indication of whether the resources required by the model to be executed are not available at the second network node (502).

Embodiment 31: The method of any of embodiments 19-30 wherein the first network node (500) comprises one or more of: an Operation and management (OAM) node; and a service and management orchestration (SMO) node, while the second network node (502) comprises one or more of: a RAN node (such as NG-RAN node); a function of a RAN node (gNB, gNB-CU-CP, . . . ); a network node realizing at least in part a Non-Real Time Radio Intelligent Controller (Non-Real Time RIC); a network node realizing at least in part a Near-Real Time RIC; a Core Network node; and a Cloud-based centralized training node.

Embodiment 32: The method of any of embodiments 19-31, further comprising: obtaining user data; and forwarding the user data to a host computer or a wireless device.

### Group C Embodiments

Embodiment 33: A first network node (500) or second network node (502) comprising: processing circuitry configured to perform any of the steps of any of the Group A embodiments and/or Group B embodiments; and power supply circuitry configured to supply power to the first network node (500) or second network node (502).

Embodiment 34: A base station, the base station comprising: processing circuitry configured to perform any of the steps of any of the Group B embodiments; and power supply circuitry configured to supply power to the base station.

Embodiment 35: A User Equipment, UE, the UE comprising: an antenna configured to send and receive wireless signals; radio front-end circuitry connected to the antenna and to processing circuitry, and configured to condition signals communicated between the antenna and the processing circuitry; the processing circuitry being configured to perform any steps; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 36: A communication system including a host computer comprising: processing circuitry configured to provide user data; and a communication interface configured to forward the user data to a cellular network for transmission to a User Equipment, UE; wherein the cellular network comprises a base station having a radio interface and processing circuitry, the base station's processing circuitry configured to perform any of the steps of any of the Group B embodiments.

Embodiment 37: The communication system of embodiment 36 further including the base station.

Embodiment 38: The communication system of any of embodiments 36-37, further including the UE, wherein the UE is configured to communicate with the base station.

Embodiment 39: The communication system of any of embodiments 36-38, wherein: the processing circuitry of the host computer is configured to execute a host application, thereby providing the user data; and the UE comprises processing circuitry configured to execute a client application associated with the host application.

Embodiment 40: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the base station performs any of the steps of any of the Group B embodiments.

Embodiment 41: The method of embodiment 40, further comprising, at the base station, transmitting the user data.

Embodiment 42: The method of any of embodiments 40-41, wherein the user data is provided at the host computer by executing a host application, the method further comprising, at the UE, executing a client application associated with the host application.

Embodiment 43: A User Equipment, UE, configured to communicate with a base station, the UE comprising a radio interface and processing circuitry configured to perform the method of the previous 3 embodiments.

Embodiment 44: A communication system including a host computer comprising: processing circuitry configured to provide user data; and a communication interface configured to forward user data to a cellular network for transmission to a User Equipment, UE; wherein the UE comprises a radio interface and processing circuitry, the UE's components configured to perform any steps.

Embodiment 45: The communication system of embodiment 44, wherein the cellular network further includes a base station configured to communicate with the UE.

Embodiment 46: The communication system of any of embodiments 44-45, wherein: the processing circuitry of the host computer is configured to execute a host application, thereby providing the user data; and the UE's processing circuitry is configured to execute a client application associated with the host application.

Embodiment 47: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the UE performs any steps.

Embodiment 48: The method of embodiment 47, further comprising at the UE, receiving the user data from the base station.

Embodiment 49: A communication system including a host computer comprising: communication interface configured to receive user data originating from a transmission from a User Equipment, UE, to a base station; wherein the UE comprises a radio interface and processing circuitry, the UE's processing circuitry configured to perform any steps.

Embodiment 50: The communication system of embodiment 49, further including the UE.

Embodiment 51: The communication system of any of embodiments 49-50, further including the base station, wherein the base station comprises a radio interface configured to communicate with the UE and a communication interface configured to forward to the host computer the user data carried by a transmission from the UE to the base station.

Embodiment 52: The communication system of any of embodiments 49-51, wherein: the processing circuitry of the host computer is configured to execute a host application; and the UE's processing circuitry is configured to execute a client application associated with the host application, thereby providing the user data.

Embodiment 53: The communication system of any of embodiments 49-52, wherein: the processing circuitry of the host computer is configured to execute a host application, thereby providing request data; and the UE's processing circuitry is configured to execute a client application associated with the host application, thereby providing the user data in response to the request data.

Embodiment 54: A method implemented in a communication system including a host computer, a base station, and a User Equipment, UE, the method comprising: at the host computer, receiving user data transmitted to the base station from the UE.

Embodiment 55: The method of embodiment 54, further comprising, at the UE, providing the user data to the base station.

Embodiment 56: The method of any of embodiments 54-55, further comprising: at the UE, executing a client application, thereby providing the user data to be transmitted; and at the host computer, executing a host application associated with the client application.

Embodiment 57: The method of any of embodiments 54-56, further comprising: at the UE, executing a client application; and at the UE, receiving input data to the client application, the input data being provided at the host computer by executing a host application associated with the client application; wherein the user data to be transmitted is provided by the client application in response to the input data.

Embodiment 58: A communication system including a host computer comprising a communication interface configured to receive user data originating from a transmission from a User Equipment, UE, to a base station, wherein the base station comprises a radio interface and processing circuitry, the base station's processing circuitry configured to perform any of the steps of any of the Group B embodiments.

Embodiment 59: The communication system of embodiment 58 further including the base station.

Embodiment 60: The communication system of any of embodiments 58-59, further including the UE, wherein the UE is configured to communicate with the base station.

Embodiment 61: The communication system of any of embodiments 58-60, wherein: the processing circuitry of the host computer is configured to execute a host application; and the UE is configured to execute a client application associated with the host application, thereby providing the user data to be received by the host computer.

Embodiment 62: A method implemented in a communication system including a host computer, a base station, and a User Equipment, UE, the method comprising: at the host computer, receiving, from the base station, user data originating from a transmission which the base station has received from the UE.

Embodiment 63: The method of embodiment 62, further comprising at the base station, receiving the user data from the UE

Embodiment 64: The method of any of embodiments 62-63, further comprising at the base station, initiating a transmission of the received user data to the host computer.

Embodiment 65: A first network node (500) configured for transmitting a FIRST MESSAGE towards a second network node (502), the FIRST MESSAGE comprising verification information for verifying a model; and/or receiving a SECOND MESSAGE transmitted by the second network node (502), the SECOND MESSAGE comprising a report associated with verifying a model.

Embodiment 66: The first network node (500) of embodiment 65 further configured to perform any of embodiments 2 to 18

Embodiment 67: A second network node (502) configured for receiving a FIRST MESSAGE transmitted by a first network node (500), the FIRST MESSAGE comprising verification information for verifying a model; and/or transmitting a SECOND MESSAGE towards the first network node (500), the SECOND MESSAGE comprising a report associated with verifying a model.

Embodiment 68: The second network node (502) of embodiment 67 further configured to perform any of embodiments 20 to 32.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation.
5GC Fifth Generation Core
5GS Fifth Generation System
AF Application Function
AI Artificial Intelligence
AMF Access and Mobility Management Function
AIML Artificial Intelligence Machine Learning
AN Access Network
ASIC
Application Specific Integrated Circuit
Authentication Server Function
Central Processing Unit
AUSF
CPU
DCI Downlink Control Information
DN Data Network
DQN Deep Q-network
DSP Digital Signal Processor
eNB Enhanced or Evolved Node B
E-UTRA Evolved Universal Terrestrial Radio Access
E-UTRAN Evolved Universal Terrestrial Radio Access Network
FFS For Further Study
FPGA Field Programmable Gate Array
gNB New Radio Base Station
gNB-CU New Radio Base Station Central Unit
gNB-CU-CP New Radio Base Station Central Unit Control Plane
gNB-CU-UP New Radio Base Station Central Unit User Plane
gNB-DU New Radio Base Station Distributed Unit
HSS Home Subscriber Server
IAB Integrated Access and Backhaul
loT Internet of Things
IP Internet Protocol
LTE Long Term Evolution
MAC Medium Access Control
MAE Mean Absolute Error
ML Machine Learning
MME Mobility Management Entity.
MR-DC Multi RAT Dual Connectivity
MSE Mean Square Error
MTC Machine Type Communication
NEF Network Exposure Function.
NF Network Function
NG Next Generation.
NG-RANNext Generation Radio Access Network
NMS Network Management System
Non-RT RIC Non-Real Time RAN Intelligent Controller
NR New Radio
NRF Network Function Repository Function
NSSF Network Slice Selection Function
OAM Operations, Administration, and Maintenance
O-CU Open Central Unit
O-CU-CP Open Central Unit Control Plane
ONAP Open Network Automation Platform
ONNX Open Neural Network exchange
ORAN Open Radio Access Network
O-RU Open Radio Unit
O-DU Open Distributed Unit
OTT Over-the-Top
PC Personal Computer
Policy Control Function
PCF PDSCH Physical Downlink Shared Channel
P-GW Packet Data Network Gateway
PPO Proximal Policy Optimization
PRS Positioning Reference Signal
QoS Quality of ServiceF
RAM Random Access Memory
RAN Radio Access Network
RAT Radio Access Technology
RELU Rectified Linear Unit
RIC Radio Intelligent Controller
RMSE Root Mean Square Error
ROM Read Only Memory.
RP Reception Point.
RRH Remote Radio Head
RT-RIC Real Time RAN Intelligent Controller
RTT Round Trip Time
SCEF Service Capability Exposure Function
SI Study Item.
SMF Session Management Function
SMO Service and Management Orchestration
TCI Transmission Configuration Indicator
TP Transmission Point
TR Technical Report
TRP Transmission/Reception Point
UDM Unified Data Management
UE User Equipment
UPF User Plane Function

Those skilled in the art will recognize improvements and modifications to the embodiments of the present disclosure. All such improvements and modifications are considered within the scope of the concepts disclosed herein.

1.-35. (canceled)

36. A method performed by a first network node, the method comprising:
transmitting a FIRST MESSAGE towards a second network node, the FIRST MESSAGE comprising verification information for verifying a model, wherein the verification information comprises configurations/instructions/semantics information for verifying the model; and
receiving a SECOND MESSAGE transmitted by the second network node, the SECOND MESSAGE comprising a report associated with verifying the model, wherein the report is based on the verification information received with the FIRST MESSAGE.

37. The method of claim 36 wherein the verification information provided to the second network node is intended for verifying that the model can perform as per tested and validated performance at the first network node or at least as per an acceptable performance level.

38. The method of claim 36 wherein receiving the SECOND MESSAGE from the second network node comprises receiving the report associated with verifying the model without prior transmission of the FIRST MESSAGE to the second network node.

39. The method of claim 36 further comprising: providing, either with the FIRST MESSAGE or with a THIRD MESSAGE, the model to the second network node and the verification information for verifying the model associated to the model provided by the first network node.

40. The method of claim 36 further comprising: providing to the second network node, either with the FIRST MESSAGE or with the THIRD MESSAGE, a set of reference data samples which can be used to verify the model.

41. The method of claim 40 wherein the set of reference data samples is provided with the FIRST MESSAGE as part of the configuration for verifying the model.

42. The method of claim 40 wherein the provided reference data samples are explicitly associated to one or more models.

43. The method of claim 40 wherein the provided reference data samples comprise one or more of:
a set of reference input-output pairs, where each reference output value represents that output that is expected to obtain for the corresponding reference input data when provided to the model for verification; and
reference state-action pairs, wherein the reference action represents either the expected output of the model or the decision of an AIML algorithm using the model, when feeding the model with the reference state.

44. The method of claim 36 wherein the configuration for verifying the model may comprise one or more information elements in the group of:
an identity or an identifier of the model to which the configuration for verification is applicable to or associated to;
an indication to verify the model;
an instruction to verify the model; and
a recommendation to verify the model.

45. The method of claim 36 wherein the verification information for verifying the model comprises one or more information related to verifying the model in the group of:
one or more conditions or events to be fulfilled for triggering the verification of the model indicated by the first network node;
one or more instructions or policies or recommendations related to verification of the model indicated by the first network node;
a request to transmit to the first network node a report comprising information associated to the verification of the model indicated by the first network node;
one or more conditions or events to be fulfilled for transmitting the report to the first network node comprising information associated to the verification of the model indicated by the first network node;
one or more conditions or events to be fulfilled for transmitting/forwarding the configuration for verifying the model;
weight factors for each input needed by the model, namely revealing the importance/priority of each input type with respect to the process of inference carried out by the model;
frequency and/or frequency ranges and/or cumulative amount of samples in a given time window, with which each type of input is assumed to be received in order to allow the model to perform according to its tested performance or according to a sufficiently good performance level established by the first node;
frequency and/or frequency ranges and/or cumulative number of samples in a given time window, with which each type of output is assumed to be generated in order to allow the model to perform according to its tested performance or according to a sufficiently good performance level established by the first node; and
semantics of the inputs needed at the model and/or of the outputs generated by the model.

46. The method of claim 36 wherein the first network node comprises one or more of:
an Operation and Management, OAM, node; and a Service and Management Orchestration, SMO, node, while the second network node comprises one or more of: a Radio Access Network, RAN, node; a Next Generation Radio Access Network, NG-RAN, node; a function of the RAN node; a network node realizing at least in part a Non-Real Time Radio Intelligent Controller, RIC; a network node realizing at least in part a Near-Real Time RIC; a Core Network node; and
a Cloud-based centralized training node.

47. A method performed by a second network node, the method comprising:
receiving a FIRST MESSAGE transmitted by a first network node, the FIRST MESSAGE comprising verification information for verifying a model, wherein the verification information for verifying the model comprises configurations/instructions/semantics information for verifying the model; and
transmitting a SECOND MESSAGE towards the first network node, the SECOND MESSAGE comprising a report associated with verifying the model, wherein the report is based on the verification information received within the FIRST MESSAGE.

48. The method of claim 47 wherein the SECOND MESSAGE is transmitted towards the first network node without previously receiving the FIRST MESSAGE from the first network node, wherein the second network node, without previous configurations/instructions/semantics from the first network node, verifies the model and notifies the first network node of inconsistencies between the instructions/configurations/semantics relative to the inputs and/or outputs, provided prior to using the model, and the actual availability of inputs and/or outputs over connected interfaces to the second network node.

49. The method of claim 47 further comprising signaling the result of the verification/testing/validation process to any other external node or system in a network, to enable a system diagnostic and system optimization.

50. The method of claim 47 further comprising: receiving, either with the FIRST MESSAGE or with a THIRD MESSAGE, the model from the first network node.

51. The method of claim 50 wherein the configuration for verifying the model provided with the FIRST MESSAGE is associated to the model provided by the first network node to the second network node.

52. The method of claims 47 further comprising one or more of:
transmitting a FOURTH MESSAGE towards a third network node, the FOURTH MESSAGE comprising at least part of configurations/instructions/semantics information for verifying the model received from the first network node; and
receiving a FIFTH MESSAGE transmitted by the third network node, the FIFTH MESSAGE comprising a report associated to verifying a model based on the configurations/instructions/semantics information received with the FOURTH MESSAGE.

53. The method of claim 52 further comprising: forwarding the report received from the third network node to the first network node via the SECOND MESSAGE.

54. A first network node for managing models comprising processing circuitry configured to cause the first network node to:
transmit a FIRST MESSAGE towards a second network node, the FIRST MESSAGE comprising verification information for verifying a model, wherein the verification information comprises configurations/instructions/semantics information for verifying the model; and
receive a SECOND MESSAGE transmitted by the second network node, the SECOND MESSAGE comprising a report associated with verifying the model, wherein the report is based on the verification information received with the FIRST MESSAGE.

55. A second network node for managing models comprising processing circuitry configured to cause the second network node to:
receive a FIRST MESSAGE transmitted by a first network node, the FIRST MESSAGE comprising verification information for verifying a model, wherein the verification information comprises configurations/instructions/semantics information for verifying the model; and
transmit a SECOND MESSAGE towards the first network node, the SECOND MESSAGE comprising a report associated with verifying the model, wherein the report is based on the verification information received with the FIRST MESSAGE.
